(19) United States
(12) Patent Application Publication
(10) Pub. No.: US 2024/0196899 A1
(43) Pub. Date: Jun. 20, 2024

(54) PESTICIDAL MIXTURES

(71) Applicant: ADAMA MAKHTESHIM LTD., Beer Sheva (IL)

(72) Inventors: Pradeep KULKARNI, Hyderabad (IN); Dor KESTECHER, Rehovot (IL); Ernesto BENETTI, Londrina (BR); Juliano UEBEL, Londrina (BR); Carlos Bruno PENNA BETTARELLO, Londrina (BR); Cristiane Stecca TURATTI, Londrina (BR); Mariela FAURE MLYNSKI, Gedera (IL)

(73) Assignee: ADAMA MAKHTESHIM LTD., Beer Sheva (IL)

(21) Appl. No.: 18/553,658

(22) PCT Filed: Mar. 31, 2022
(86) PCT No.: PCT/IL2022/050347

§ 371 Date: Oct. 2, 2023

(30) Foreign Application Priority Data
Apr. 2, 2021 (IN) 202131015784
Apr. 2, 2021 (IN) 202131015786
Jun. 26, 2021 (IN) 202111028811

(51) Int. Cl. A01N 47/34; A01N 37/22; A01N 43/12; A01N 43/16; A01N 43/36; A01N 43/38; A01N 43/40; A01N 43/56; A01N 43/713; A01N 43/80; A01N 43/90; A01N 47/02; A01N 47/40; A01N 47/44; A01N 57/12; A01N 57/28; A01P 7/04

(52) U.S. Cl. CPC A01N 47/34; A01N 37/22; A01N 43/12; A01N 43/16; A01N 43/36; A01N 43/38; A01N 43/40; A01N 43/56; A01N 43/713; A01N 43/80; A01N 43/90; A01N 47/02; A01N 47/40; A01N 47/44; A01N 57/12; A01N 57/28; A01P 7/04

(57) ABSTRACT

The present invention relates to novel combinations of active compounds comprising, novaluron and at least one further active compound, and to methods of controlling pests comprising applying said combinations.

This application claims benefits of three Indian Provisional Application Numbers, IN 202131015784 filed on Apr. 2, 2021; IN 202131015786 filed on Apr. 2, 2021; as well as IN 202111028811 filed on Jun. 26, 2021; the entire content of which is hereby incorporated by reference herein.

Throughout this application, various publications are cited. Disclosures of the documents and publications referred to herein are hereby incorporated in their entireties by references into this application.

### FIELD OF INVENTION

The present invention relates to novel combinations of active compounds comprising, novaluron and at least one further active compound, and to methods of controlling pests comprising applying said combinations.

### BACKGROUND OF INVENTION

The vulnerability of crops to pests makes pest control one of the major management components of the total crop production system. Insects are very destructive to crop plants and can significantly reduce crop yields and quality. Insecticides help minimize this damage by controlling insect pests. Many insecticidal agents and compositions are commercially available for these purposes.

Combinations of insecticides are typically used to broaden spectrum of control, to minimize the doses of chemicals used, to retard resistance development and to reduce the cost of the treatment through additive effect. Although many combinations of insecticidal agents have been studied, a synergistic effect is rarely attained.

Further, the activity and selectivity behavior of any specific mixture is difficult to predict since the behavior of each single insecticide in the mixture is often affected by the presence of the other components and the activity of the mixture may also vary considerably depending on chemical character, plant species, growth stage, and environmental conditions. Mostly, this practice results in reduced activity of the insecticides in the mixture.

Practical agricultural experience has shown that the repeated and exclusive application of an individual active compound in the control of insect pests leads in many cases to a selection of those pests which have developed natural or adapted resistance against the active compound in question. Effective control of these pests with the active compound in question is then no longer possible.

Another difficulty in relation to the use of insecticides is that the repeated and exclusive application of an individual insecticidal compound leads in many cases, to a rapid selection of pests which have developed natural or adapted resistance against the active compound in question. Therefore, there is a need for pest control agents that help prevent or overcome resistance. In order to reduce the risk of insect pests becoming resistant to certain active compounds, mixtures of different active compounds are nowadays conventionally employed for controlling insect pests. By combining active compounds having different mechanisms of action, it is possible to ensure successful control over a relatively long period of time.

Insect growth regulators (IGR) are substances that interrupt and/or inhibit the life cycle of insect pests. IGRs include juvenile hormone mimics, ecdysone agonists and chitin synthesis inhibitors. As an insect grows, it molts, growing a new exoskeleton under its old one and then shedding the old one in order to allow the new one to swell to a new size and harden. IGRs prevent an insect from reaching maturity by interfering with the molting process. This in turn curbs infestations since the immature insects are unable to reproduce. Because IGRs work by interfering with an insect's molting process, they take longer to kill than traditional insecticides which have immediate or fast acting knockdown effects.

The active compounds mentioned herein below are known, for example, from “The Pesticide Manual”, 11th Edition, 1997, published by the British Crop Protection Council. Novaluron is described on page 888. Novaluron is a benzoylurea having the chemical formula of (+)-I-[3-chloro-4-(1,1,2-trifluoro-2-trifluoromethoxyethoxy) phenyl]-3-(2,6-difluorobenzoyl) urea. It is already known that novaluron of the formula

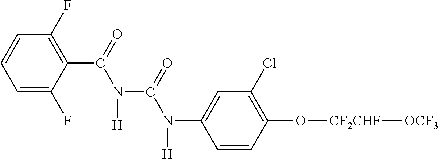

can be used for controlling animal pests, in particular insects.

Novaluron acts mainly by ingestion and contact. Novaluron disrupts post-apolytic cuticle formation, resulting in thinning of the pharate and the subsequent cuticle. This disruption of new cuticle formation leads to failed ecdysis during the molting process. Novaluron is generally used to control a wide range of pests including Lepidoptera, Coleoptera, and Diptera. The recommended application rate for novaluron is dependent on the target pests and ranges from about 1-1000 g a.i./ha.

Diacylhydrazine insecticides are ecdysone agonists which show excellent insecticidal activity by inducing precocious molting. These insecticides target Lepidoptera but are harmless to beneficial insects. These compounds mimic the natural insect molting hormone by binding competitively to ecdysteroid receptors in insect cells, therefore prematurely inducing larval molt. Examples of diacylhydrazine insecticides include chromafenozide, halofenozide, methoxyfenozide and tebufenozide.

Pyrethroid insecticides are organic compounds similar to the natural pyrethrins, which are produced by the flowers of pyrethrums, such as Chrysanthemum cinerariaefolium and C. coccineum. Pyrethroids commonly used as commercial and household insecticides, though generally harmless to humans, are toxic to insects such as bees, dragonflies, mayflies, gadflies, and some other invertebrates, mainly mediated through preventing the closure of the voltage-gated sodium channels in the axonal membranes in insects. Pyrethroid insecticides include but not limited to Tau fluvalinate, lambda-cyhalothrin and bifenthrin.

Spinosyns are a family of broad-spectrum insecticides including spinosad and spinetoram, all with a macrocyclic lactone structure, isolated from the actinomycete soil bacterium Saccharopolyspora spinosa. The spinosyns and spinosoids have a novel mode of action, primarily targeting binding sites on nicotinic acetylcholine receptors (nAChRs) of the insect nervous system that are distinct from those at which other insecticides have their activity. Spinosad has been used around the world for the control of a variety of insect pests, including Lepidoptera, Diptera, Thysanoptera, Coleoptera, Orthoptera, and Hymenoptera, and many others including thrips.

Spiropidion and spirotetramat belong to the same chemical class of insecticides (tetramic acids, cyclic ketoenoles) that act as acetyl COA carboxylase (ACC) inhibitors. These insecticides are is active against piercing-sucking insects, such as aphids, mites, and white flies, by acting as an ACC inhibitor, interrupting lipid biosynthesis in the insects.

A chemical class of METI (Mitochondrial complex I electron transport inhibitors) acaricides and insecticides, such as Tolfenpyrad, acts by inhibiting the cellular respiration in the insect resulting an excellent knock-down effect. Tolfenpyrad is an ideal rotational chemistry with an excellent tank mix partner and having good residuel efficacy to control wide range of pests.

A pyridine organic compound, such as Flonicamid, a Chortodonal Organ Modulator, is used as an insecticide on aphids, whiteflies, and thrips. It disrupts insect chordotonal organs that can affect hearing, balance, movement to cause cessation of feeding. Its mode of action is different from other insecticides such as neonicotinoids, pymetrozine and pyrifluquinazon.

The Chortodonal Organ TRPV (vanilloid-type transient receptor potential) Channel Modulators, such as pymetrozine, afidopyropen and pyrifluquinazon, specifically disrupt the feeding of plant sap-sucking insects. Pymetrozine, afidopyropen and pyrifluquinazon can directly bind to insect Nanchung (Nan) and Inactive (lav) protein.

Arylisoxazolines, such as Fluxametamid and Isocycloseram, are γ-aminobutyric acid (GABA)-gated chloride channel allosteric modulators, that demonstrate high broad-spectrum activity against various lepidopteran, thysanopteran and dipteran pest species. Meta-diamides, such as broflanilide, which are also GABA-gated chloride channel allosteric modulators have broad-spectrum activity (crop and non-crop pests) and can be used in different crops to control lepidoptera, coleoptera, termites, ants, cockroaches, and flies.

An insecticidal class of diamides (phthalic diamides and anthranilamides) act as highly specific Ryanodin receptor (RyR) modulators. Cyclaniliprole and tetraniliprole are structural analogues of the anthranilamides, chlorantraniliprole and cyantraniliprole in this class. Tetraniliprole has good activity against a broad spectrum of insect pests including lepidoptera, coleoptera, leafminer, and selected other Diptera and aphids. It can be applied as foliar and soil treatment from early to late season. Cyclaniliprole is a broad spectrum insecticide for use in leafy vegetables, cucurbits, fruiting vegetables and Brassica (cole) vegetable crops. In addition to diamide activity, lepidopteran pests are also controlled.

An arylalkyloxypyrimidine compound, such as Benzpyrimoxan, effectively controls rice planthoppers and leafhoppers with a long-lasting effect. By suppressing the molting of the larvae of planthoppers and leafhoppers, it reduces the number of insect populations in rice fields. The product has good selectivity and has little effect on non-target organisms such as pollinating insects and natural enemies.

A novel class of mesoionic pyrido[1,2-α]pyrimidinones, such as dicloromezotiaz, has insecticidal activity controlling a number of insect species. It is a potent insecticide to control a broad range of lepidoptera.

A novel quinoline insecticide, such as Flometoquin, exhibits good insecticidal activity against Plutella xylostella and Mythimna separata. It is a potent insecticide to control thrips, whiteflies and Lepidoptera.

A novel chemotype insecticide, such as Flupyrimin is effective against the major insect pests in rice, such as planthoppers and stem borers, including those populations resistant to existing insecticides. It binds to the acetylcholine site on nicotinoyl acetylcholine receptors (nAChRs), causing a range of symptoms from hyperexcitation to lethargy and paralysis in insects.

An aryl ethylsulfonyl compound, such as Oxazosulfyl exhibits broad-spectrum control of insect pests, including Hemiptera, Coleoptera, and Lepidoptera. Since this compound has a broad insecticidal spectrum, it can grow into a large group of insecticides as a highly versatile pest control agent.

Tyclopyrazoflor is a member of the class of pyrazoles, is an organofluorine compound. It is a sap-feeding insecticidal candidate. A pyrazole carboxamide insecticide, such as dimpropyridaz, has a pyridin-3-yl group, is effective against aphids.

Pyrrole compound, such as Chlorfenapyr, is a member of the class of pyrroles that is 4-bromo-1H-pyrrole-3-carbonitrile which is substituted at positions 1, 2 and 5 by ethoxymethyl, p-chlorophenyl and trifluoromethyl groups, respectively. Chlorfenapyr is used commercially for termite control and crop protection against a variety of insect and mite pests.

A sulfoximine, such as Sulfoxaflor, is an insecticide class which is an important and highly effective tool for growers that targets difficult pests such as aphids and tarnished plant bugs, and also effective against pests that are becoming resistant to carbamate, neonicotinoid, organophosphate and pyrethroid insecticides.

A furanicotinyl insecticide, such as Dinotefuran, represents the third generation of neonicotinoid group. Dinotefuran acts as an agonist of insect nicotinic acetylcholine receptors, which is highly active on a certain silverleaf whitefly strain which developed resistance against imidacloprid.

Organophosphates such as acephate and Malathion bind to and inhibit the enzyme acetylcholinesterase (AChE) in nervous system tissues, are systemic insecticides used to control sucking and biting insects by direct contact or ingestion on food crops, agricultural seed and non-bearing plants, institutions and commercial buildings including public health facilities, sod, golf course turf, ant mounds, and horticultural nursery plants.

A foliar contact insecticide or acaricide, such as Spiromesifen, belonging to the chemical class of Ketoenols, have been in use for the control of mites and whitefly on vegetables, fruits, cotton and tea. Spiromesifen is active against all the developmental stages of mites and whiteflies resulting in long lasting control.

A phenylpyrazole chemical compound, such as Fipronil is a broad-spectrum insecticide, which is used to control ants, beetles, cockroaches, fleas, ticks, termites, mole crickets, thrips, rootworms, weevils, and other insects. Fipronil is a white powder with a moldy odor.

A tetramic acid insecticide, such as Spidoxamat, has high plant mobility, which ensures high efficacy against key sucking pests (aphids, white flies) at low dose rates for foliar and soil uses, is suitable for application in arable and horticulture crops such as in soybeans, cotton, fruits and vegetables.

Phenylpyrazole insecticide, such as Nicofluprole, is a class of chemically-related broad-spectrum insecticides, which are characterized by a central pyrazole ring with a phenyl group attached to one of the nitrogen atoms of the pyrazole.

An Ecdysteroid compound, such as Ecdysone, is a steroidal prohormone of the major insect molting hormone 20-hydroxyecdysone, which is secreted from the prothoracic glands. Ecdysteroids act as moulting hormones of arthropods but also occur in other related phyla where they can play different roles.

WO 2006/048868 discloses uses of a combination of novaluron with insecticidal compound with effective knock-down action selected from imidacloprid and acetamiprid, for insect control in crops and locus thereof.

WO 2007/019962 discloses insecticidal mixtures comprising novaluron and at least one further known active compound from the group of the neonicotinoids, and to the use of these mixtures for controlling animal pests.

WO 2015/196339 discloses method of protecting rice from infestation and attack by pests and comprises contacting rice with a pesticidal composition comprising a synergistically effective amount of spinetoram and methoxyfenozide.

It is an object of the present invention to provide mixtures and compositions which, when applied at a reduced total amount of active compounds, have improved activity against the harmful pests. It is an object of the present invention to provide a broadened activity spectrum or a combination of knock-down activity with prolonged control. It is a further object of the present invention to provide mixtures and compositions which provide effective resistance management and insect pests control, at application rates which are as low as possible.

It is an endeavor of the present invention to find that mixtures comprising novaluron and at least one compound from the groups mentioned above are synergistically effective, being applied simultaneously, that is jointly or separately, or in succession, allows better control of insect pests than is possible with the individual compounds alone, providing synergistic results and solving at least one of the challenges in the prior art by reducing the dosage rate or enhancing the spectrum of activity or combining knock-down activity with prolonged control or facilitating resistance management.

In light of the above, there is endeavor in the present invention for novel insecticidal combinations and compositions that exhibit synergistically enhanced action, a broader scope of activity and reduced cost of treatment.

### SUMMARY OF THE PRESENT SUBJECT MATTER

We have reasonably found that the object as described above is as a whole or in part achieved by the combination of active compounds defined below.

The present invention relates to a pesticidal mixture comprising, as active compounds:
i) A compound I, which is novaluron of formula (I)

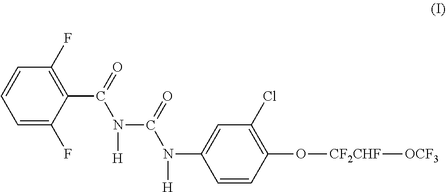

and
ii) at least one active compound II selected from the groups A.1 to A.26:
A.1. Diacylhydrazine insecticides, which are ecdysone agonists, selected from the group comprising chromafenozide, halofenozide, methoxyfenozide and tebufenozide.
A.2. Pyrethroid insecticides, selected from the group comprising Tau fluvalinate, lambda-cyhalothrin and bifenthrin.
A.3. Spinosyns insecticides, selected from the group comprising spinosad and spinetoram.
A.4. Tetramic acids, cyclic ketoenoles insecticides, which are acetyl CoA carboxylase (ACC) inhibitors, selected from the group comprising Spiropidion and spirotetramat.
A.5. METI (Mitochondrial complex I electron transport inhibitors) acaricides and insecticides, selected from the group comprising Tolfenpyrad.
A.6. A pyridine organic compound, which is a Chortodonal Organ Modulator, selected from the group comprising Flonicamid.
A.7. The Chortodonal Organ TRPV (vanilloid-type transient receptor potential) Channel Modulators, selected from the group comprising pymetrozine, afidopyropen and pyrifluquinazon.
A.8. Arylisoxazolines, which are γ-aminobutyric acid (GABA)-gated chloride channel allosteric modulators, selected from the group comprising Fluxametamid and Isocycloseram.
A.9. Meta-diamides, which are GABA-gated chloride channel allosteric modulators, selected from the group comprising broflanilide.
A.10. An insecticidal class of diamides, which are highly specific Ryanodin receptor (RyR) modulators, selected from the group comprising Cyclaniliprole and tetraniliprole.
A.11. An arylalkyloxypyrimidine compound, selected from the group comprising
Benzpyrimoxan.
A.12. A mesoionic pyrido[1,2-α]pyrimidinones, selected from the group comprising dicloromezotiaz.
A.13. A novel quinoline insecticide, selected from the group comprising Flometoquin.
A.14. A novel chemotype insecticide, selected from the group comprising Flupyrimin.
A.15. An aryl ethylsulfonyl compound, selected from the group comprising Oxazosulfyl.
A.16. An organofluorine compound, selected from the group comprising Tyclopyrazoflor.
A.17. A pyrazole carboxamide insecticide, selected from the group comprising dimpropyridaz.
A.18. A Pyrrole compound, selected from the group comprising Chlorfenapyr.
A.19. A sulfoximine compound, selected from the group comprising Sulfoxaflor.
A.20. A furanicotinyl compound, selected from the group comprising Dinotefuran.
A.21. An organophosphate compound, selected from the group comprising Acephate and Malathion.
A.22. A foliar contact insecticide, selected from the group comprising Spiromesifen.
A.23. A phenylpyrazole chemical compound, selected from the group comprising Fipronil.
A.24. A tetramic acid insecticide, selected from the group comprising Spidoxamat.
A.25. A Phenylpyrazole insecticide, selected from the group comprising Nicofluprole.
A.26. An Ecdysteroid compound, selected from the group comprising Ecdysone.

Furthermore, it is found in the present invention that simultaneous, that is jointly or separately, application of one active compound I, that is novaluron and one or more active compounds II or successive application of novaluron and one or more active compounds II, as mentioned above, allows enhanced control of pests compared to the control rates that are possible with the individual compounds.

The present invention provides the insecticidal mixture, wherein the weight ratio of novaluron and one or more active compounds II, as mentioned above is from 1:100 to 100:1.

The present invention further provides a pesticidal composition comprising a mixture of novaluron and one or more active compounds II, as mentioned above, comprising an agriculturally acceptable carrier, and further comprising at least one surfactant, solid diluent, liquid diluent, or a combination thereof.

The present invention also provides a method for controlling insects, acarids or nematodes comprising contacting the insect, acarid or nematode or their food supply, habitat, breeding grounds or their locus with a pesticidally effective amount of the mixture according to the invention.

The present invention further provides a method of reducing the total amount of insecticidal active compounds necessary for controlling unwanted pests by a) applying novaluron at an application rate from about 25% to about 75% of the recommended application rate and b) applying one or more active compounds II, as mentioned above.

This present invention also provides a method for controlling insects comprising contacting the insect or their food supply, habitat, breeding grounds or their locus with an effective amount of the mixture of novaluron and one or more active compounds II, as mentioned above or the composition thereof, so as to thereby control insects.

The present invention further provides a method for protecting plants from attack or infestation by insects comprising contacting the plant, or the soil or water in which the plant is growing, with an effective amount of the mixture of novaluron and one or more active compounds II, as mentioned above or the composition thereof, so as to thereby protect plants from attack or infestation by insects.

This present invention also provides a method for enhancing knock-down activity and/or prolonged control comprising contacting the plant, or the soil or water in which the plant is growing, with an effective amount of the mixture of novaluron and one or more active compounds II, as mentioned above or the composition thereof, so as to thereby enhance knock-down activity and/or prolonged control.

This present invention further provides a method for enhancing plant development comprising applying to the plant, a locus of the plant and/or propagation material of the plant an effective amount of the mixture of novaluron and one or more active compounds II, as mentioned above or the composition thereof, so as to thereby enhance plant development.

Furthermore, this present invention provides a method for regulating plant growth comprising applying to the plant, a locus of the plant and/or propagation material of the plant an effective amount of novaluron and one or more active compounds II, as mentioned above or the composition thereof, so as to thereby regulate plant growth.

### DETAILED DESCRIPTION OF THE PRESENT SUBJECT MATTER

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains.

As used herein, the term “pests” is used to include animal pests, as well as harmful fungi.

As used herein, the term “AI” refers to active ingredient.

As used herein, the terms “control” or “controlling” are meant to include, but are not limited to, any killing, growth regulating, inhibiting or interfering with the normal life cycle of the pest activities of a given pest. These terms include for example preventing larvae from developing into mature insects, modulating the emergence of pests from eggs including preventing eclosion, degrading the egg material, suffocation, reducing gut motility, inhibiting the formation of chitin, disrupting mating or sexual communication, and preventing feeding activity. The terms “control” and “controlling” also include the ability to modulate or inhibit the growth or proliferation or colony formation of an organism or an organism population.

As used herein the term “knock-down activity” or “knock-down treatment” means an application of one or more insecticides for controlling insect infestation of the plant or locus before and/or after an infestation or before and/or after insect damage are shown and/or when the pest pressure is low/high. Insect pressure may be assessed based on the conditions associated with insect development such as population density and certain environmental conditions.

As used herein the term “prolonged control” means obtaining insecticidal activity over an extended period after the application of one or more insecticide for controlling insect infestation of the plant or locus over an extended period of time, before and/or after an infestation or before and/or after insect damage are shown and/or when the insect pressure is low/high. Insect pressure may be assessed based on the conditions associated with insect development such as population density and certain environmental conditions.

As used herein, the term “effective” when used to describe a method for controlling of undesired pest, such as nematodes, means that the method provides a good level of control of the undesired pest without significantly interfering with the normal growth and development of the crop.

As used herein, the term “effective amount” when used in connection with an active component refers to an amount of the active component that, when ingested, contacted with or sensed, is sufficient to achieve a good level of control or activity.

As used herein, the term “effective amount” when used in connection with a non-active component, i.e. additive, such as polymer and organic carrier, refers to an amount of the additive that is sufficient to improve the stability of the composition.

As used herein, the term “agriculturally acceptable carrier” means carrier which is known and accepted in the art for the formation of compositions for agricultural or horticultural use.

As used herein, the term “adjuvant” is broadly defined as any substance that itself is not an active ingredient, but which enhances or is intended to enhance the effectiveness of the pesticide with which it is used. Adjuvants may be understood to include, but are not limited to, spreading agents, penetrants, compatibility agents, and drift retardants.

As used herein, the term “agriculturally acceptable inert additives” is defined as any substance that itself is not an active ingredient but is added to the composition such as thickening agent, sticking agents, surfactants, anti-oxidation agent, anti-foaming agents and thickeners.

As used herein, the term “tank mix” means that two or more chemical pesticides or compositions are mixed in the spray tank at the time of spray application.

As used herein, the term “ready mix” means a composition that may be applied to plants directly after dilution. The composition comprises the combination of the active ingredients.

As used herein the term “plant” includes reference to the whole plant, plant organ (e.g., leaves, stems, twigs, roots, trunks, limbs, shoots, fruits etc.), and propagation material or plant cells.

As used herein the term “plant” includes reference to agricultural crops including field crops, vegetable crops, fruits, semi-perennial crops and perennial crops.

As used herein the term “propagation material” is to be understood to denote all the generative parts of the plant such as seeds and spores, vegetative structures such as bulbs, corms, tubers, rhizomes, roots stems, basal shoots, stolons and buds.

As used herein, the term “locus” includes a habitat, breeding ground, plant, propagation material, soil, area, material or environment in which a pest is growing or may grow.

As used herein the term “ha” refers to hectare.

As used herein, the term “g” refers to gram, and “L” or “I” refers to litre.

As used herein, the term “mixture” or “combination” refers, but is not limited to, a combination in any physical form, e.g., blend, solution, suspension, dispersion, emulsion, alloy, or the like.

As used herein, the term “more effective” includes, but is not limited to, increasing efficacy of pesticidal disease control, prolonging protection and reducing the amount of time needed to achieve a given level of pesticidal control, prolonging the duration of protection against pest attack after application and extending the protection period against pest attack and/or reducing the amount of time needed to achieve a level of pest control compared to when each pesticide at the same amount is applied alone.

As used herein, the term “cultivated plants” includes plants which have been modified by breeding, mutagenesis or genetic engineering. Genetically modified plants are plants, which genetic material has been modified by the use of recombinant DNA techniques. Typically, one or more genes have been integrated into the genetic material of such a plant in order to improve certain properties of the plant.

The term “enhancing crop plants” as used herein means improving one or more of plant quality, plant vigor, nutrient uptake, root system, tolerance to stress factors, and/or yield in a plant to which the mixture or composition described herein has been applied as compared to a control plant grown under the same conditions except to which the mixture or composition described herein has not been applied.

The term “enhancing roots system” as used herein means the roots system is improved qualitatively or quantitatively in a plant to which the mixture or composition described herein has been applied as compared to the roots systems in a control plant grown under the same conditions except to which the mixture or composition described herein has not been applied. Enhanced roots systems include but are not limited to improved visual appearance and composition of the roots system (i.e., improved color, density, and uniformity), increased root growth, a more developed root system, stronger and healthier roots, improved plant stand, and increased roots system weight.

The term “improving plant quality” as used herein means that one or more traits are improved qualitatively or quantitatively in a plant to which the mixture or composition described herein has been applied as compared to the same trait in a control plant grown under the same conditions except to which the mixture or composition described herein has not been applied. Such traits include but are not limited to improved visual appearance and composition of the plant (i.e., improved color, density, uniformity, compactness), reduced ethylene (reduced production and/or inhibition of reception), improved visual appearance and composition of harvested material (i.e., seeds, fruits, leaves, vegetables, shoot/stem/cane), improved carbohydrate content (i.e., increased quantities of sugar and/or starch, improved sugar acid ratio, reduction of reducing sugars, increased rate of development of sugar), improved protein content, improved oil content and composition, improved nutritional value, reduction in anti-nutritional compounds, increased nutrient uptake, stronger and healthier roots, improved organoleptic properties (i.e., improved taste), improved consumer health benefits (i.e., increased levels of vitamins and antioxidants), improved post-harvest characteristics (i.e., enhanced shelf-life and/or storage stability, easier processability, easier extraction of compounds), and/or improved seed quality (i.e., for use in following seasons).

As used herein, the term “plant growth regulation” or “regulating plant growth” includes restricting vertical stem growth, promoting root growth, stunting, increasing stem diameter and stem-wall thickness, and the like.

As used herein, the term “plants” refers to any and all physical parts of a plant, including but not limited to seeds, seedlings, saplings, roots, tubers, stems, stalks, foliage, and fruits.

As used herein, the term “surfactant” means an agriculturally acceptable material which imparts emulsifiability, stability, spreading, wetting, dispersibility or other surface-modifying properties. Examples of suitable surfactants include non-ionic, anionic, cationic and ampholytic surfactants.

The term “a” or “an” as used herein includes the singular and the plural, unless specifically stated otherwise. Therefore, the terms “a,” “an” or “at least one” can be used interchangeably in this application.

Throughout the application, descriptions of various embodiments use the term “comprising”; however, it will be understood by one of skill in the art, that in some specific instances, an embodiment can alternatively be described using the language “consisting essentially of” or “consisting of”.

For purposes of better understanding the present teachings and in no way limiting the scope of the teachings, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques. In this regard, use of the term “about” herein specifically includes ±10% from the indicated values in the range. In addition, the endpoints of all ranges directed to the same component or property herein are inclusive of the endpoints, are independently combinable, and include all intermediate points and ranges.

Unless otherwise specified, references to percentages are by weight (wt.) percentages of the active compounds in the composition of this invention are based on the total weight of active ingredients in the composition, i.e., the active compounds themselves, exclusive of any amounts of solvents, carriers, dispersants, stabilizers or other materials which may be present.

It is further understood that where a parameter range is provided, all integers within that range, and tenths thereof, are also provided by the subject matter. For example, “0.1% to 50%” includes 0.1%, 0.2%, 0.3%, 0.4% etc. up to 50%.

When a ratio herein is to be “X:1 or higher”, it is meant that the ratio is Y:1, where Y is X or greater, and when a ratio is herein to be “X:1 or lower”, it is meant that the ratio is Z:1, where Z is X or less. The same logic follows for ratios that are “1:X or higher” and “1:X or lower”.

### Pesticidal Mixtures

It has been surprisingly found that by combining insecticides, insecticidal mixtures are produced, that exhibit a broad spectrum of control and high efficacy against a very wide range of insects, as well as having knock-down and long residual effect under different climate conditions. The mixtures and compositions of the present invention are based in part on the finding that application of the novel insecticidal mixture of the present invention to a locus or area where pest control is desired results in improved control of pests and prevents further infestation.

In some embodiments, the combination provides a higher insecticidal activity than that envisaged on the basis of the sum of activities of each of the insecticides found therein. Such a combination allows the reduced dosages of the individual insecticides which can damage agriculturally important plants.

In an embodiment, the present invention relates to a pesticidal mixture comprising, as active compounds:
i) a compound I, which is novaluron, and
ii) at least one active compound II selected from the groups A.1 to A.26:
A.1. Diacylhydrazine insecticides, which are ecdysone agonists, selected from the group comprising chromafenozide, halofenozide, methoxyfenozide and tebufenozide.
A.2. Pyrethroid insecticides, selected from the group comprising Tau fluvalinate, lambda-cyhalothrin and bifenthrin.
A.3. Spinosyns insecticides, selected from the group comprising spinosad and spinetoram.
A.4. Tetramic acids, cyclic ketoenoles insecticides, which are acetyl CoA carboxylase (ACC) inhibitors, selected from the group comprising Spiropidion and spirotetramat.
A.5. METI (Mitochondrial complex I electron transport inhibitors) acaricides and insecticides, selected from the group comprising Tolfenpyrad.
A.6. A pyridine organic compound, which is a Chortodonal Organ Modulator, selected from the group comprising Flonicamid.
A.7. The Chortodonal Organ TRPV (vanilloid-type transient receptor potential) Channel Modulators, selected from the group comprising pymetrozine, afidopyropen and pyrifluquinazon.
A.8. Arylisoxazolines, which are γ-aminobutyric acid (GABA)-gated chloride channel allosteric modulators, selected from the group comprising Fluxametamid and Isocycloseram.
A.9. Meta-diamides, which are GABA-gated chloride channel allosteric modulators, selected from the group comprising broflanilide.
A.10. An insecticidal class of diamides, which are highly specific Ryanodin receptor (RyR) modulators, selected from the group comprising Cyclaniliprole and tetraniliprole.
A.11. An arylalkyloxypyrimidine compound, selected from the group comprising Benzpyrimoxan.
A.12. A mesoionic pyrido[1,2-α]pyrimidinones, selected from the group comprising dicloromezotiaz.
A.13. A novel quinoline insecticide, selected from the group comprising Flometoquin.
A.14. A novel chemotype insecticide, selected from the group comprising Flupyrimin.
A.15. An aryl ethylsulfonyl compound, selected from the group comprising Oxazosulfyl.
A.16. An organofluorine compound, selected from the group comprising Tyclopyrazoflor.
A.17. A pyrazole carboxamide insecticide, selected from the group comprising dimpropyridaz.
A.18. A Pyrrole compound, selected from the group comprising Chlorfenapyr.
A.19. A sulfoximine compound, selected from the group comprising Sulfoxaflor.
A.20. A furanicotinyl compound, selected from the group comprising Dinotefuran.
A.21. An organophosphate compound, selected from the group comprising Acephate and Malathion.
A.22. A foliar contact insecticide, selected from the group comprising Spiromesifen.
A.23. A phenylpyrazole chemical compound, selected from the group comprising Fipronil.
A.24. A tetramic acid insecticide, selected from the group comprising Spidoxamat.
A.25. A Phenylpyrazole insecticide, selected from the group comprising Nicofluprole.
A.26. An Ecdysteroid compound, selected from the group comprising Ecdysone.

With respect to the use in the pesticidal mixture of the present invention, the active compound II is selected from the groups A.1, A.2, A.3, A.4, A.5, A.6, A.7, A.8, A.9, A.10, A.11, A.12, A.13, A.14, A.15, A.16, A.17, A.18, A.19, A.20, A.21, A.22, A.23, A.24, A.25 and A.26, preferably selected from the group A.1, A.3, A.4, A.7, A.8, A.9, A.10, A.12, A.14, A.16, A.18, A.19, A.20, A.21, A.22, A.23 and A.25.

With regard the pesticidal mixture of the present invention, the active compound II selected from group A.1 as defined above, is preferably chromafenozide, halofenozide, methoxyfenozide and tebufenozide, and more preferably methoxyfenozide.

With regard to the pesticidal mixture of the present invention, the active compound II selected from group A.2 as defined above, is preferably tau fluvalinate.

With regard to the pesticidal mixture of the present invention, the active compound II selected from group A.3 as defined above, is more preferably spinosad or spinetoram.

With regard to the pesticidal mixture of the present invention, the active compound II selected from group A.4 as defined above, is preferably spiropidion or spirotetramat.

With regard to the pesticidal mixture of the present invention, the active compound II selected from group A.4 as defined above, is more preferably spirotetramat.

With regard to the pesticidal mixture of the present invention, the active compound II selected from group A.5 as defined above, is preferably tolfenpyrad.

With regard to the pesticidal mixture of the present invention, the active compound II selected from group A.6 as defined above, is preferably flonicamid.

With regard to the pesticidal mixture of the present invention, the active compound II selected from group A.7 as defined above, is preferably pymetrozine or afidopyropen.

With regard to the pesticidal mixture of the present invention, the active compound II selected from group A.7 as defined above, is more preferably afidopyropen.

With regard to the pesticidal mixture of the present invention, the active compound II selected from group A.8 as defined above, is preferably fluxametamid or isocycloseram.

With regard to the pesticidal mixture of the present invention, the active compound II selected from group A.8 as defined above, is more preferably isocycloseram.

With regard to the pesticidal mixture of the present invention, the active compound II selected from group A.9 as defined above, is more preferably broflanilide.

With regard to the pesticidal mixture of the present invention, the active compound II selected from group A.10 as defined above, is preferably cyclaniliprole or tetraniliprole.

With regard to the pesticidal mixture of the present invention, the active compound II selected from group A.10 as defined above, is more preferably tetraniliprole.

With regard to the pesticidal mixture of the present invention, the active compound II selected from group A.11 as defined above, is preferably benzpyrimoxan.

With regard to the pesticidal mixture of the present invention, the active compound II selected from group A.12 as defined above, is more preferably dicloromezotiaz.

With regard to the pesticidal mixture of the present invention, the active compound II selected from group A.13 as defined above, is preferably flometoquin.

With regard to the pesticidal mixture of the present invention, the active compound II selected from group A.14 as defined above, is more preferably flupyrimin.

With regard to the pesticidal mixture of the present invention, the active compound II selected from group A.15 as defined above, is preferably oxazosulfyl.

With regard to the pesticidal mixture of the present invention, the active compound II selected from group A.16 as defined above, is more preferably tyclopyrazoflor.

With regard to the pesticidal mixture of the present invention, the active compound II selected from group A.17 as defined above, is preferably dimpropyridaz.

With regard to the pesticidal mixture of the present invention, the active compound II selected from group A.18 as defined above, is more preferably Chlorfenapyr.

With regard to the pesticidal mixture of the present invention, the active compound II selected from group A.19 as defined above, is more preferably Sulfoxaflor.

With regard to the pesticidal mixture of the present invention, the active compound II selected from group A.20 as defined above, is more preferably Dinotefuran.

With regard to the pesticidal mixture of the present invention, the active compound II selected from group A.21 as defined above, is more preferably Acephate or Malathion.

With regard to the pesticidal mixture of the present invention, the active compound II selected from group A.22 as defined above, is more preferably Spiromesifen.

With regard to the pesticidal mixture of the present invention, the active compound II selected from group A.23 as defined above, is more preferably Fipronil.

With regard to the pesticidal mixture of the present invention, the active compound II selected from group A.24 as defined above, is preferably Spidoxamat.

With regard to the pesticidal mixture of the present invention, the active compound II selected from group A.25 as defined above, is more preferably Nicofluprole.

With regard to the pesticidal mixture of the present invention, the active compound II selected from group A.26 as defined above, is preferably Ecdysone.

In one embodiment the insecticidal mixture allows enhanced control of pests is achieved compared to the control rates that are possible with the individual active compounds, wherein the said mixture is prepared by simultaneous, that is jointly or separately, application of novaluron and one or more active compounds II or successive application of novaluron and one or more active compounds II, as mentioned above.

In another embodiment, present invention provides the insecticidal mixture, wherein the weight ratio of novaluron and one or more active compounds II, as mentioned above is from 1:100 to 100:1.

In an embodiment, present invention provides the insecticidal mixture, wherein the weight ratio of novaluron and an Diacylhydrazine insecticide is from 1:100 to 100:1.

In a further embodiment, present invention provides the insecticidal mixture, wherein the weight ratio of novaluron and Methoxyfenozide is from 1:100 to 100:1.

In a specific embodiment, present invention provides the insecticidal mixture, wherein the weight ratio of novaluron and Methoxyfenozide is from 1:1 to 100:1.

In an embodiment, present invention provides the insecticidal mixture, wherein the weight ratio of novaluron and Spinosyns insecticide is from 1:100 to 100:1.

In a further embodiment, present invention provides the insecticidal mixture, wherein the weight ratio of novaluron and Spinosad is from 1:100 to 100:1.

In a specific embodiment, present invention provides the insecticidal mixture, wherein the weight ratio of novaluron and Spinosad is from 1:1 to 1:100.

In another specific embodiment, present invention provides the insecticidal mixture, wherein the weight ratio of novaluron and Spinetoram is from 1:100 to 100:1.

In another specific embodiment, present invention provides the insecticidal mixture, wherein the weight ratio of novaluron and Spinetoram is from 1:5 to 5:1.

In an embodiment, present invention provides the insecticidal mixture, wherein the weight ratio of novaluron and acetyl COA carboxylase (ACC) inhibitors insecticide is from 1:100 to 100:1.

In a further embodiment, present invention provides the insecticidal mixture, wherein the weight ratio of novaluron and Spirotetramat is from 1:100 to 100:1.

In a specific embodiment, present invention provides the insecticidal mixture, wherein the weight ratio of novaluron and Spirotetramat is from 1:1 to 1:100.

In an embodiment, present invention provides the insecticidal mixture, wherein the weight ratio of novaluron and Chortodonal Organ TRPV (vanilloid-type transient receptor potential) Channel Modulator insecticide is from 1:100 to 100:1.

In a further embodiment, present invention provides the insecticidal mixture, wherein the weight ratio of novaluron and afidopyropen is from 1:100 to 100:1.

In a specific embodiment, present invention provides the insecticidal mixture, wherein the weight ratio of novaluron and afidopyropen is from 1:5 to 5:1.

In an embodiment, present invention provides the insecticidal mixture, wherein the weight ratio of novaluron and Arylisoxazolines, which are γ-aminobutyric acid (GABA)-gated chloride channel allosteric modulators insecticide is from 1:100 to 100:1.

In a further embodiment, present invention provides the insecticidal mixture, wherein the weight ratio of novaluron and Isocycloseram is from 1:100 to 100:1.

In a specific embodiment, present invention provides the insecticidal mixture, wherein the weight ratio of novaluron and Isocycloseram is 1:1.

In an embodiment, present invention provides the insecticidal mixture, wherein the weight ratio of novaluron and Meta-diamides, which are GABA-gated chloride channel allosteric modulators insecticide is from 1:100 to 100:1.

In a further embodiment, present invention provides the insecticidal mixture, wherein the weight ratio of novaluron and Broflanilide is from 1:100 to 100:1.

In a specific embodiment, present invention provides the insecticidal mixture, wherein the weight ratio of novaluron and Broflanilide is from 1:1 to 10:1.

In an embodiment, present invention provides the insecticidal mixture, wherein the weight ratio of novaluron and specific Ryanodin receptor (RyR) modulators insecticide is from 1:100 to 100:1.

In a further embodiment, present invention provides the insecticidal mixture, wherein the weight ratio of novaluron and Tetraniliprole is from 1:100 to 100:1.

In a specific embodiment, present invention provides the insecticidal mixture, wherein the weight ratio of novaluron and Tetraniliprole is from 1:5 to 25:1.

In an embodiment, present invention provides the insecticidal mixture, wherein the weight ratio of novaluron and mesoionic pyrido[1,2-α]pyrimidinones insecticide is from 1:100 to 100:1.

In a further embodiment, present invention provides the insecticidal mixture, wherein the weight ratio of novaluron and Dicloromezotiaz is from 1:100 to 100:1.

In a specific embodiment, present invention provides the insecticidal mixture, wherein the weight ratio of novaluron and Dicloromezotiaz is 1:1.

In an embodiment, present invention provides the insecticidal mixture, wherein the weight ratio of novaluron and chemotype insecticide is from 1:100 to 100:1.

In a further embodiment, present invention provides the insecticidal mixture, wherein the weight ratio of novaluron and Flupyrimin is from 1:100 to 100:1.

In a specific embodiment, present invention provides the insecticidal mixture, wherein the weight ratio of novaluron and Flupyrimin is 1:1.

In an embodiment, present invention provides the insecticidal mixture, wherein the weight ratio of novaluron and organofluorine compound is from 1:100 to 100:1.

In a further embodiment, present invention provides the insecticidal mixture, wherein the weight ratio of novaluron and Tyclopyrazoflor is from 1:100 to 100:1.

In a specific embodiment, present invention provides the insecticidal mixture, wherein the weight ratio of novaluron and Tyclopyrazoflor is 1:1.

In an embodiment, present invention provides the insecticidal mixture, wherein the weight ratio of novaluron and Pyrrole compound is from 1:100 to 100:1.

In a further embodiment, present invention provides the insecticidal mixture, wherein the weight ratio of novaluron and Chlorfenapyr is from 1:100 to 100:1.

In a specific embodiment, present invention provides the insecticidal mixture, wherein the weight ratio of novaluron and Chlorfenapyr is from 1:10 to 50:1.

In an embodiment, present invention provides the insecticidal mixture, wherein the weight ratio of novaluron and sulfoximine compound is from 1:100 to 100:1.

In a further embodiment, present invention provides the insecticidal mixture, wherein the weight ratio of novaluron and Sulfoxaflor is from 1:100 to 100:1.

In a specific embodiment, present invention provides the insecticidal mixture, wherein the weight ratio of novaluron and Sulfoxaflor is from 1:5 to 100:1.

In an embodiment, present invention provides the insecticidal mixture, wherein the weight ratio of novaluron and furanicotinyl compound is from 1:100 to 100:1.

In a further embodiment, present invention provides the insecticidal mixture, wherein the weight ratio of novaluron and Dinotefuran is from 1:100 to 100:1.

In a specific embodiment, present invention provides the insecticidal mixture, wherein the weight ratio of novaluron and Dinotefuran is 1:1.

In an embodiment, present invention provides the insecticidal mixture, wherein the weight ratio of novaluron and organophosphate compound is from 1:100 to 100:1.

In a further embodiment, present invention provides the insecticidal mixture, wherein the weight ratio of novaluron and Acephate is from 1:100 to 100:1.

In a further embodiment, present invention provides the insecticidal mixture, wherein the weight ratio of novaluron and Acephate is from 1:10 to 10:1.

In a further embodiment, present invention provides the insecticidal mixture, wherein the weight ratio of novaluron and Malathion is from 1:100 to 100:1.

In a specific embodiment, present invention provides the insecticidal mixture, wherein the weight ratio of novaluron and Acephate is 1:10.

In a specific embodiment, present invention provides the insecticidal mixture, wherein the weight ratio of novaluron and Malathion is from 1:1 to 1:10.

In an embodiment, present invention provides the insecticidal mixture, wherein the weight ratio of novaluron and foliar contact insecticide is from 1:100 to 100:1.

In a further embodiment, present invention provides the insecticidal mixture, wherein the weight ratio of novaluron and Spiromesifen is from 1:100 to 100:1.

In a specific embodiment, present invention provides the insecticidal mixture, wherein the weight ratio of novaluron and Spiromesifen is from 1:5 to 100:1.

In an embodiment, present invention provides the insecticidal mixture, wherein the weight ratio of novaluron and phenylpyrazole chemical compound is from 1:100 to 100:1.

In a further specific embodiment, present invention provides the insecticidal mixture, wherein the weight ratio of novaluron and Fipronil is from 1:100 to 100:1.

In an embodiment, present invention provides the insecticidal mixture, wherein the weight ratio of novaluron and Phenylpyrazole insecticide is from 1:100 to 100:1.

In a further embodiment, present invention provides the insecticidal mixture, wherein the weight ratio of novaluron and Nicofluprole is from 1:100 to 100:1.

In a specific embodiment, present invention provides the insecticidal mixture, wherein the weight ratio of novaluron and Nicofluprole is 1:1.

In another embodiment, the present invention further provides a pesticidal composition comprising a mixture of novaluron and one or more active compounds II, as mentioned above, comprising an agriculturally acceptable carrier, and further comprising at least one surfactant, solid diluent, liquid diluent, or a combination thereof.

In further embodiment, the present invention also provides a method for controlling insects, acarids or nematodes comprising contacting the insect, acarid or nematode or their food supply, habitat, breeding grounds or their locus with a pesticidally effective amount of the mixture according to the invention.

In an embodiment, the present invention further provides a method of reducing the total amount of insecticidal active compounds necessary for controlling unwanted pests by a) applying novaluron at an application rate from about 25% to about 75% of the recommended application rate and b) applying one or more active compounds II, as mentioned above.

In further embodiment, this present invention also provides a method for controlling insects comprising contacting the insect or their food supply, habitat, breeding grounds or their locus with an effective amount of the mixture of novaluron and one or more active compounds II, as mentioned above or the composition thereof, so as to thereby control insects.

In an embodiment, the present invention further provides a method for protecting plants from attack or infestation by insects comprising contacting the plant, or the soil or water in which the plant is growing, with an effective amount of the mixture of novaluron and one or more active compounds II, as mentioned above or the composition thereof, so as to thereby protect plants from attack or infestation by insects.

In another embodiment, this present invention also provides a method for enhancing knock-down activity and/or prolonged control comprising contacting the plant, or the soil or water in which the plant is growing, with an effective amount of the mixture of novaluron and one or more active compounds II, as mentioned above or the composition thereof, so as to thereby enhance knock-down activity and/or prolonged control.

In one of the embodiments, this present invention further provides a method for enhancing plant development comprising applying to the plant, a locus of the plant and/or propagation material of the plant an effective amount of the mixture of novaluron and one or more active compounds II, as mentioned above or the composition thereof, so as to thereby enhance plant development.

In further embodiments, this present invention provides a method for regulating plant growth comprising applying to the plant, a locus of the plant and/or propagation material of the plant an effective amount of novaluron and one or more active compounds II, as mentioned above or the composition thereof, so as to thereby regulate plant growth.

In another embodiment, this present invention provides a composition comprising an effective amount of novaluron and one or more active compounds II, as mentioned above, wherein the effective amounts of both the active compounds are chosen in such a manner that the mixture thereof results in synergistic insecticidal activity.

In a representative embodiment, an enhanced synergistic insecticidal activity is observed when an insecticidal mixture of novaluron and a diacylhydrazine insecticide is used for the control of insects.

In another representative embodiment, the present subject matter relates to an insecticidal mixture comprising novaluron and a diacylhydrazine insecticide.

In an embodiment, the diacylhydrazine insecticide is chromafenozide, halofenozide, methoxyfenozide, tebufenozide, or a combination comprising at least one of the foregoing. In one representative embodiment, the diacylhydrazine compound is methoxyfenozide.

In one representative embodiment, the present subject matter also provides a pesticidal mixture comprising: (i) an amount of novaluron; and (ii) an amount of methoxyfenozide.

In some embodiments, the amount of novaluron and the amount of a diacylhydrazine insecticide if applied together are more effective than when novaluron, at the same amount, and the diacylhydrazine insecticide at the same amount, is applied alone.

In some embodiments, the amount of novaluron and the amount of methoxyfenozide if applied together are more effective than when novaluron, at the same amount, and methoxyfenozide at the same amount, is applied alone.

In some embodiments, the amount of novaluron applied is less than the insecticidal effective amount of novaluron, if novaluron is used alone.

In a representative embodiment, the amount of the diacylhydrazine insecticide applied is less than the insecticidal effective amount of the diacylhydrazine insecticide if the diacylhydrazine insecticide is used alone. Specifically, in some embodiments, the amount of methoxyfenozide applied is less than the insecticidal effective amount of methoxyfenozide if methoxyfenozide is used alone.

In some embodiments, the mixture is more effective than if novaluron at the same amount, and the diacylhydrazine insecticide at the same amount, are applied alone.

In some embodiments, the mixture is more effective than if novaluron at the same amount, and the methoxyfenozide insecticide at the same amount, are applied alone.

In some embodiments, the present subject matter also provides a pesticidal mixture comprising: (i) novaluron; and (ii) an amount of a diacylhydrazine insecticide, wherein the mixture is more effective than (i) and/or (ii) at the same amount is applied alone.

In some embodiments, the present subject matter provides a pesticidal mixture comprising: (i) novaluron; and (ii) an amount of methoxyfenozide, wherein the mixture is more effective than (i) and/or (ii) at the same amount is applied alone.

In an embodiment, the present subject matter provides a pesticidal mixture comprising: (i) novaluron; and (ii) an amount of Spinosad, wherein the mixture is more effective than (i) and/or (ii) at the same amount is applied alone.

In an embodiment, the present subject matter provides a pesticidal mixture comprising: (i) novaluron; and (ii) an amount of Spinetoram, wherein the mixture is more effective than (i) and/or (ii) at the same amount is applied alone.

In an embodiment, the present subject matter provides a pesticidal mixture comprising:

(i) novaluron; and (ii) an amount of Spirotetramat, wherein the mixture is more effective than (i) and/or (ii) at the same amount is applied alone.

In an embodiment, the present subject matter provides a pesticidal mixture comprising: (i) novaluron; and (ii) an amount of afidopyropen, wherein the mixture is more effective than (i) and/or (ii) at the same amount is applied alone.

In an embodiment, the present subject matter provides a pesticidal mixture comprising: (i) novaluron; and (ii) an amount of Isocycloseram, wherein the mixture is more effective than (i) and/or (ii) at the same amount is applied alone.

In an embodiment, the present subject matter provides a pesticidal mixture comprising: (i) novaluron; and (ii) an amount of Broflanilide, wherein the mixture is more effective than (i) and/or (ii) at the same amount is applied alone.

In an embodiment, the present subject matter provides a pesticidal mixture comprising:

(i) novaluron; and (ii) an amount of Tetraniliprole, wherein the mixture is more effective than (i) and/or (ii) at the same amount is applied alone.

In an embodiment, the present subject matter provides a pesticidal mixture comprising: (i) novaluron; and (ii) an amount of Dicloromezotiaz, wherein the mixture is more effective than (i) and/or (ii) at the same amount is applied alone.

In an embodiment, the present subject matter provides a pesticidal mixture comprising: (i) novaluron; and (ii) an amount of Flupyrimin, wherein the mixture is more effective than (i) and/or (ii) at the same amount is applied alone.

In an embodiment, the present subject matter provides a pesticidal mixture comprising: (i) novaluron; and (ii) an amount of Tyclopyrazoflor, wherein the mixture is more effective than (i) and/or (ii) at the same amount is applied alone.

In an embodiment, the present subject matter provides a pesticidal mixture comprising: (i) novaluron; and (ii) an amount of Chlorfenapyr, wherein the mixture is more effective than (i) and/or (ii) at the same amount is applied alone.

In an embodiment, the present subject matter provides a pesticidal mixture comprising:

(i) novaluron; and (ii) an amount of Sulfoxaflor, wherein the mixture is more effective than (i) and/or (ii) at the same amount is applied alone.

In an embodiment, the present subject matter provides a pesticidal mixture comprising: (i) novaluron; and (ii) an amount of Dinotefuran, wherein the mixture is more effective than (i) and/or (ii) at the same amount is applied alone.

In an embodiment, the present subject matter provides a pesticidal mixture comprising: (i) novaluron; and (ii) an amount of Acephate, wherein the mixture is more effective than (i) and/or (ii) at the same amount is applied alone.

In an embodiment, the present subject matter provides a pesticidal mixture comprising: (i) novaluron; and (ii) an amount of Malathion, wherein the mixture is more effective than (i) and/or (ii) at the same amount is applied alone.

In an embodiment, the present subject matter provides a pesticidal mixture comprising:

(i) novaluron; and (ii) an amount of Spiromesifen, wherein the mixture is more effective than (i) and/or (ii) at the same amount is applied alone.

In an embodiment, the present subject matter provides a pesticidal mixture comprising: (i) novaluron; and (ii) an amount of Fipronil, wherein the mixture is more effective than (i) and/or (ii) at the same amount is applied alone.

In an embodiment, the present subject matter provides a pesticidal mixture comprising: (i) novaluron; and (ii) an amount of Nicofluprole, wherein the mixture is more effective than (i) and/or (ii) at the same amount is applied alone.

In some embodiments, mixture exhibits synergistic effects.

In some embodiments, the mixture is a synergistic mixture.

In one embodiment, the present subject matter relates to a synergistic pesticidal mixture comprising: (i) novaluron; and (ii) at least one active compound II selected from the groups A.1, A.3, A.4, A.7, A.8, A.9, A.10, A.12, A.14, A.16, A.18, A.19, A.20, A.21, A.22, A.23 and A.25 as defined above.

In a representative embodiment, the present subject matter relates to a synergistic pesticidal mixture comprising: (i) novaluron; and (ii) a diacylhydrazine insecticide.

In a further representative embodiment, the present subject matter relates to a synergistic pesticidal mixture comprising: (i) novaluron; and (ii) methoxyfenozide.

In some embodiments, (i) the amount of novaluron and (ii) an amount of a diacylhydrazine insecticide in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of methoxyfenozide in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of methoxyfenozide in a ratio from 1:1 to 100:1, if applied together are more effective in treating a plant or soil against insect infection than if (i) at the same amount, and (ii) at the same amount, is applied alone.

In some embodiments, (i) the amount of novaluron and (ii) an amount of a Spinosyns insecticide in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Spinosad in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Spinosad in a ratio from 1:1 to 1:100, if applied together are more effective in treating a plant or soil against insect infection than if (i) at the same amount, and (ii) at the same amount, is applied alone.

In some embodiments, (i) the amount of novaluron and (ii) an amount of Spinetoram in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of an acetyl CoA carboxylase (ACC) inhibitors insecticide in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Spirotetramat in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Spirotetramat in a ratio from 1:1 to 1:100, if applied together are more effective in treating a plant or soil against insect infection than if (i) at the same amount, and (ii) at the same amount, is applied alone.

In some embodiments, (i) the amount of novaluron and (ii) an amount of Chortodonal Organ TRPV (vanilloid-type transient receptor potential) Channel Modulator insecticide in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of afidopyropen in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of afidopyropen in a ratio from 1:5 to 5:1, if applied together are more effective in treating a plant or soil against insect infection than if (i) at the same amount, and (ii) at the same amount, is applied alone.

In some embodiments, (i) the amount of novaluron and (ii) an amount of Arylisoxazolines, which are γ-aminobutyric acid (GABA)-gated chloride channel allosteric modulators insecticide in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Isocycloseram in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Isocycloseram in a ratio of 1:1, if applied together are more effective in treating a plant or soil against insect infection than if (i) at the same amount, and (ii) at the same amount, is applied alone.

In some embodiments, (i) the amount of novaluron and (ii) an amount of Meta-diamides, which are GABA-gated chloride channel allosteric modulators insecticide in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Broflanilide in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Broflanilide in a ratio from 1:1 to 10:1, if applied together are more effective in treating a plant or soil against insect infection than if (i) at the same amount, and (ii) at the same amount, is applied alone.

In some embodiments, (i) the amount of novaluron and (ii) an amount specific Ryanodin receptor (RyR) modulators insecticide in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount specific Tetraniliprole in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount specific Tetraniliprole in a ratio from 1:5 to 25:1, if applied together are more effective in treating a plant or soil against insect infection than if (i) at the same amount, and (ii) at the same amount, is applied alone.

In some embodiments, (i) the amount of novaluron and (ii) an amount mesoionic pyrido[1,2-α]pyrimidinones insecticide in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount Dicloromezotiaz in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount Dicloromezotiaz in a ratio of 1:1, if applied together are more effective in treating a plant or soil against insect infection than if (i) at the same amount, and (ii) at the same amount, is applied alone.

In some embodiments, (i) the amount of novaluron and (ii) an amount chemotype insecticide in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount Flupyrimin in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount Flupyrimin in a ratio of 1:1, if applied together are more effective in treating a plant or soil against insect infection than if (i) at the same amount, and (ii) at the same amount, is applied alone.

In some embodiments, (i) the amount of novaluron and (ii) an amount of organofluorine compound in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Tyclopyrazoflor in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Tyclopyrazoflor in a ratio of 1:1, if applied together are more effective in treating a plant or soil against insect infection than if (i) at the same amount, and (ii) at the same amount, is applied alone.

In some embodiments, (i) the amount of novaluron and (ii) an amount of Pyrrole compound in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Chlorfenapyr in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Chlorfenapyr in a ratio from 1:10 to 50:1, if applied together are more effective in treating a plant or soil against insect infection than if (i) at the same amount, and (ii) at the same amount, is applied alone.

In some embodiments, (i) the amount of novaluron and (ii) an amount of sulfoximine compound in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Sulfoxaflor in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Sulfoxaflor in a ratio from 1:5 to 100:1, if applied together are more effective in treating a plant or soil against insect infection than if (i) at the same amount, and (ii) at the same amount, is applied alone.

In some embodiments, (i) the amount of novaluron and (ii) an amount of furanicotinyl compound in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Dinotefuran in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Dinotefuran in a ratio of 1:1, if applied together are more effective in treating a plant or soil against insect infection than if (i) at the same amount, and (ii) at the same amount, is applied alone.

In some embodiments, (i) the amount of novaluron and (ii) an amount of organophosphate compound in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Acephate in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Acephate in a ratio of 1:10, if applied together are more effective in treating a plant or soil against insect infection than if (i) at the same amount, and (ii) at the same amount, is applied alone.

In some embodiments, (i) the amount of novaluron and (ii) an amount of Malathion in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Malathion in a ratio from 1:1 to 1:10, if applied together are more effective in treating a plant or soil against insect infection than if (i) at the same amount, and (ii) at the same amount, is applied alone.

In some embodiments, (i) the amount of novaluron and (ii) an amount of foliar contact insecticide in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Spiromesifen in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Spiromesifen in a ratio from 1:5 to 100:1, if applied together are more effective in treating a plant or soil against insect infection than if (i) at the same amount, and (ii) at the same amount, is applied alone.

In some embodiments, (i) the amount of novaluron and (ii) an amount of phenylpyrazole chemical compound in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Fipronil in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Phenylpyrazole insecticide in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Nicofluprole in a ratio from 1:100 to 100:1, if applied together are more effective in treating a plant or soil against insect infection than if (i) at the same amount, and (ii) at the same amount, is applied alone.

In some embodiments, (i) the amount of novaluron and (ii) an amount of Nicofluprole in a ratio of 1:1, if applied together are more effective in treating a plant or soil against insect infection than if (i) at the same amount, and (ii) at the same amount, is applied alone.

In a further embodiment, the pesticidal mixture of the invention comprising: (i) novaluron; and (ii) at least one active compound II as defined above, is synergistically effective for controlling pests compared to when at least one component of the mixture at the same amount is applied alone, after several hours to several days of applications.

In an embodiment, the pesticidal mixture of the invention comprising: (i) novaluron; and (ii) Methoxyfenozide, is synergistically effective for controlling pests compared to when at least one component of the mixture at the same amount is applied alone, after 72 hours of applications.

In an embodiment, the pesticidal mixture of the invention comprising: (i) novaluron; and (ii) Methoxyfenozide, is synergistically effective for controlling pests compared to when at least one component of the mixture at the same amount is applied alone, after 4 days of applications.

In an embodiment, the pesticidal mixture of the invention comprising: (i) novaluron; and (ii) Methoxyfenozide, is synergistically effective for controlling pests compared to when at least one component of the mixture at the same amount is applied alone, after 8 days of applications.

In an embodiment, the pesticidal mixture of the invention comprising: (i) novaluron; and (ii) Spinosad, is synergistically effective for controlling pests compared to when at least one component of the mixture at the same amount is applied alone, after 48 hours of applications.

In an embodiment, the pesticidal mixture of the invention comprising: (i) novaluron; and (ii) Spinosad, is synergistically effective for controlling pests compared to when at least one component of the mixture at the same amount is applied alone, after 72 hours of applications.

In an embodiment, the pesticidal mixture of the invention comprising: (i) novaluron; and (ii) Spinosad, is synergistically effective for controlling pests compared to when at least one component of the mixture at the same amount is applied alone, after 7 days of applications.

In an embodiment, the pesticidal mixture of the invention comprising: (i) novaluron; and (ii) Spinetoram, is synergistically effective for controlling pests compared to when at least one component of the mixture at the same amount is applied alone, after 48 hours of applications.

In an embodiment, the pesticidal mixture of the invention comprising: (i) novaluron; and (ii) Spinetoram, is synergistically effective for controlling pests compared to when at least one component of the mixture at the same amount is applied alone, after 72 hours of applications.

In an embodiment, the pesticidal mixture of the invention comprising: (i) novaluron; and (ii) Spinetoram, is synergistically effective for controlling pests compared to when at least one component of the mixture at the same amount is applied alone, after 120 hours of applications.

In an embodiment, the pesticidal mixture of the invention comprising: (i) novaluron; and (ii) Spinetoram, is synergistically effective for controlling pests compared to when at least one component of the mixture at the same amount is applied alone, after 7 days of applications.

In an embodiment, the pesticidal mixture of the invention comprising: (i) novaluron; and (ii) Spirotetramat, is synergistically effective for controlling pests compared to when at least one component of the mixture at the same amount is applied alone, after 48 hours of applications.

In an embodiment, the pesticidal mixture of the invention comprising: (i) novaluron; and (ii) Spirotetramat, is synergistically effective for controlling pests compared to when at least one component of the mixture at the same amount is applied alone, after 72 hours of applications.

In an embodiment, the pesticidal mixture of the invention comprising: (i) novaluron; and (ii) Spirotetramat, is synergistically effective for controlling pests compared to when at least one component of the mixture at the same amount is applied alone, after 7 days of applications.

In an embodiment, the pesticidal mixture of the invention comprising: (i) novaluron; and (ii) afidopyropen, is synergistically effective for controlling pests compared to when at least one component of the mixture at the same amount is applied alone, after 72 hours of applications.

In an embodiment, the pesticidal mixture of the invention comprising: (i) novaluron; and (ii) Isocycloseram, is synergistically effective for controlling pests compared to when at least one component of the mixture at the same amount is applied alone, after 72 hours of applications.

In an embodiment, the pesticidal mixture of the invention comprising: (i) novaluron; and (ii) Broflanilide, is synergistically effective for controlling pests compared to when at least one component of the mixture at the same amount is applied alone, after 120 hours of applications.

In an embodiment, the pesticidal mixture of the invention comprising: (i) novaluron; and (ii) Tetraniliprole, is synergistically effective for controlling pests compared to when at least one component of the mixture at the same amount is applied alone, after 72 hours of applications.

In an embodiment, the pesticidal mixture of the invention comprising: (i) novaluron; and (ii) Tetraniliprole, is synergistically effective for controlling pests compared to when at least one component of the mixture at the same amount is applied alone, after 120 hours of applications.

In an embodiment, the pesticidal mixture of the invention comprising: (i) novaluron; and (ii) Dicloromezotiaz, is synergistically effective for controlling pests compared to when at least one component of the mixture at the same amount is applied alone, after 72 hours of applications.

In an embodiment, the pesticidal mixture of the invention comprising: (i) novaluron; and (ii) Flupyrimin, is synergistically effective for controlling pests compared to when at least one component of the mixture at the same amount is applied alone, after 72 hours of applications.

In an embodiment, the pesticidal mixture of the invention comprising: (i) novaluron; and (ii) Tyclopyrazoflor, is synergistically effective for controlling pests compared to when at least one component of the mixture at the same amount is applied alone, after 72 hours of applications.

In an embodiment, the pesticidal mixture of the invention comprising: (i) novaluron; and (ii) Chlorfenapyr, is synergistically effective for controlling pests compared to when at least one component of the mixture at the same amount is applied alone, after 48 hours of applications.

In an embodiment, the pesticidal mixture of the invention comprising: (i) novaluron; and (ii) Chlorfenapyr, is synergistically effective for controlling pests compared to when at least one component of the mixture at the same amount is applied alone, after 72 hours of applications.

In an embodiment, the pesticidal mixture of the invention comprising: (i) novaluron; and (ii) Chlorfenapyr, is synergistically effective for controlling pests compared to when at least one component of the mixture at the same amount is applied alone, after 7 days of applications.

In an embodiment, the pesticidal mixture of the invention comprising: (i) novaluron; and (ii) Sulfoxaflor, is synergistically effective for controlling pests compared to when at least one component of the mixture at the same amount is applied alone, after 48 hours of applications.

In an embodiment, the pesticidal mixture of the invention comprising: (i) novaluron; and (ii) Sulfoxaflor, is synergistically effective for controlling pests compared to when at least one component of the mixture at the same amount is applied alone, after 72 hours of applications.

In an embodiment, the pesticidal mixture of the invention comprising: (i) novaluron; and (ii) Dinotefuran, is synergistically effective for controlling pests compared to when at least one component of the mixture at the same amount is applied alone, after 72 hours of applications.

In an embodiment, the pesticidal mixture of the invention comprising: (i) novaluron; and (ii) Acephate, is synergistically effective for controlling pests compared to when at least one component of the mixture at the same amount is applied alone, after 72 hours of applications.

In an embodiment, the pesticidal mixture of the invention comprising: (i) novaluron; and (ii) Acephate, is synergistically effective for controlling pests compared to when at least one component of the mixture at the same amount is applied alone, after 7 days of applications.

In an embodiment, the pesticidal mixture of the invention comprising: (i) novaluron; and (ii) Malathion, is synergistically effective for controlling pests compared to when at least one component of the mixture at the same amount is applied alone, after 72 hours of applications.

In an embodiment, the pesticidal mixture of the invention comprising: (i) novaluron; and (ii) Malathion, is synergistically effective for controlling pests compared to when at least one component of the mixture at the same amount is applied alone, after 96 hours of applications.

In an embodiment, the pesticidal mixture of the invention comprising: (i) novaluron; and (ii) Spiromesifen, is synergistically effective for controlling pests compared to when at least one component of the mixture at the same amount is applied alone, after 96 hours of applications.

In an embodiment, the pesticidal mixture of the invention comprising: (i) novaluron; and (ii) Spiromesifen, is synergistically effective for controlling pests compared to when at least one component of the mixture at the same amount is applied alone, after 7 days of applications.

In an embodiment, the pesticidal mixture of the invention comprising: (i) novaluron; and (ii) Fipronil, is synergistically effective for controlling pests compared to when at least one component of the mixture at the same amount is applied alone, after 72 hours of applications.

In an embodiment, the pesticidal mixture of the invention comprising: (i) novaluron; and (ii) Fipronil, is synergistically effective for controlling pests compared to when at least one component of the mixture at the same amount is applied alone, after 144 hours of applications.

In an embodiment, the pesticidal mixture of the invention comprising: (i) novaluron; and (ii) Fipronil, is synergistically effective for controlling pests compared to when at least one component of the mixture at the same amount is applied alone, after 7 days of applications.

In an embodiment, the pesticidal mixture of the invention comprising: (i) novaluron; and (ii) Nicofluprole, is synergistically effective for controlling pests compared to when at least one component of the mixture at the same amount is applied alone, after 72 hours of applications.

In some embodiments, the mixture reduces the amount of time needed to achieve a level of pest control compared to when at least one component of the mixture at the same amount is applied alone. An example for reduction is, if novaluron applied alone achieves 50% insecticidal control 7 days after application, the mixture or combination disclosed herein achieves 50% insecticidal control 2 days after application where each insecticide is applied at the amount.

In some embodiments, the amount of time is reduced by at least 1 day, 2 days, 3 days, 4 day, 5 days, 7 days, 10 days, 14 days or 21 days, or 28 days.

In some embodiments, the mixture is effective for increasing plant development compared to when at least one component of the mixture at the same amount is applied alone. Increasing plant development includes, but is not limited to, enhancing the root systems, enhancing shoot of the crop plant, enhancing plant vigor and/or enhancing plant potential yield.

In some embodiments, the effectiveness is measured as increases in plant vigor, plant yield, enhancement in root system and/or enhancement in shoot.

In some embodiments, plant vigor is assessed using the relative vigor index. In some embodiments, plant vigor is increased by at least 1%, 5%, 10, 20%, 30%, 40% or 50%.

In some embodiments, enhancement in root system is measured by root weight. In some embodiments, root weight is increased by at least 1%, 5%, 10, 20%, 30%, 40% or 50%.

In some embodiments, enhancement in shoot is measured by shoot weight. In some embodiments, shoot weight is increased by at least 1%, 5%, 10, 20%, 30%, 40% or 50%.

The weight ratio between novaluron and one of the active compound II as defined above, in the composition cannot generally be defined, as it varies depending upon various conditions such as the type of the formulation, weather conditions, the type of crop and the type of pests.

In one embodiment, the weight ratio of novaluron to the diacylhydrazine insecticide in the composition is from about 1:100 to 100:1. In another embodiment, the weight ratio of novaluron to the diacylhydrazine insecticide is from about 1:1 to 100:1. In a specific embodiment, the weight ratio of novaluron to the diacylhydrazine insecticide is 1:1. In another specific embodiment, the weight ratio of novaluron to the diacylhydrazine insecticide is 100:1. The weight ratio of novaluron to the diacylhydrazine insecticide may be an intermediate range selected from the above indicated ratios.

In one embodiment, the weight ratio of novaluron to the methoxyfenozide in the composition is from about 1:100 to 100:1. In another embodiment, the weight ratio of novaluron to the methoxyfenozide insecticide is from about 1:1 to 100:1. In a specific embodiment, the weight ratio of novaluron to the methoxyfenozide insecticide is 1:1. In another specific embodiment, the weight ratio of novaluron to the methoxyfenozide insecticide is 100:1. The weight ratio of novaluron to the methoxyfenozide insecticide may be an intermediate range selected from the above indicated ratios.

In one embodiment, the weight ratio of novaluron to the Spinosyns insecticide in the composition is from about 1:100 to 100:1. In another embodiment, the weight ratio of novaluron to the Spinosyns insecticide is from about 1:1 to 100:1. In another embodiment, the weight ratio of novaluron to the Spinosyns insecticide is from about 1:100 to 1:1. In another embodiment, the weight ratio of novaluron to the Spinosyns insecticide is from about 1:5 to 1:1. In another embodiment, the weight ratio of novaluron to the Spinosyns insecticide is from about 5:1 to 1:1. In a specific embodiment, the weight ratio of novaluron to the Spinosyns insecticide is 1:1. In another specific embodiment, the weight ratio of novaluron to the Spinosyns insecticide is 100:1. In another specific embodiment, the weight ratio of novaluron to the Spinosyns insecticide is 5:1. In another specific embodiment, the weight ratio of novaluron to the Spinosyns insecticide is 1:100. In another specific embodiment, the weight ratio of novaluron to the Spinosyns insecticide is 1:5. In another specific embodiment, the weight ratio of novaluron to the Spinosyns insecticide is 1:2.5. The weight ratio of novaluron to the Spinosyns insecticide may be an intermediate range selected from the above indicated ratios.

In one embodiment, the weight ratio of novaluron to the Spinosad in the composition is from about 1:100 to 100:1. In another embodiment, the weight ratio of novaluron to the Spinosad insecticide is from about 1:100 to 1:1. In a specific embodiment, the weight ratio of novaluron to Spinosad is 1:1. In another specific embodiment, the weight ratio of novaluron to the Spinosad is 1:100. The weight ratio of novaluron to Spinosad may be an intermediate range selected from the above indicated ratios.

In one embodiment, the weight ratio of novaluron to Spinetoram in the composition is from about 1:100 to 100:1. In another embodiment, the weight ratio of novaluron to Spinetoram is from about 1:1 to 100:1. In another embodiment, the weight ratio of novaluron to Spinetoram is from about 1:100 to 1:1. In another embodiment, the weight ratio of novaluron to Spinetoram is from about 1:5 to 1:1. In another embodiment, the weight ratio of novaluron to Spinetoram is from about 5:1 to 1:1. In a specific embodiment, the weight ratio of novaluron to Spinetoram is 1:1. In another specific embodiment, the weight ratio of novaluron to Spinetoram is 100:1. In another specific embodiment, the weight ratio of novaluron to Spinetoram is 5:1. In another specific embodiment, the weight ratio of novaluron to Spinetoram is 1:100. In another specific embodiment, the weight ratio of novaluron to Spinetoram is 1:5. In another specific embodiment, the weight ratio of novaluron to Spinetoram is 1:2.5. The weight ratio of novaluron to Spinetoram may be an intermediate range selected from the above indicated ratios.

In one embodiment, the weight ratio of novaluron to acetyl CoA carboxylase (ACC) inhibitors insecticide in the composition is from about 1:100 to 100:1. In another embodiment, the weight ratio of novaluron to acetyl CoA carboxylase (ACC) inhibitors insecticide is from about 1:1 to 1:100. In a specific embodiment, the weight ratio of novaluron to acetyl CoA carboxylase (ACC) inhibitors insecticide is 1:1. In another specific embodiment, the weight ratio of novaluron to acetyl COA carboxylase (ACC) inhibitors insecticide is 1:100. The weight ratio of novaluron to acetyl CoA carboxylase (ACC) inhibitors insecticide may be an intermediate range selected from the above indicated ratios.

In one embodiment, the weight ratio of novaluron to Spirotetramat in the composition is from about 1:100 to 100:1. In another embodiment, the weight ratio of novaluron to Spirotetramat is from about 1:1 to 1:100. In a specific embodiment, the weight ratio of novaluron to Spirotetramat is 1:1. In another specific embodiment, the weight ratio of novaluron to Spirotetramat is 1:100. The weight ratio of novaluron to Spirotetramat may be an intermediate range selected from the above indicated ratios.

In one embodiment, the weight ratio of novaluron to Chortodonal Organ TRPV (vanilloid-type transient receptor potential) Channel Modulator insecticide in the composition is from about 1:100 to 100:1. In another embodiment, the weight ratio of novaluron to Chortodonal Organ TRPV (vanilloid-type transient receptor potential) Channel Modulator insecticide is from about 1:5 to 5:1. In a specific embodiment, the weight ratio of novaluron to Chortodonal Organ TRPV (vanilloid-type transient receptor potential) Channel Modulator insecticide is 1:5. In another specific embodiment, the weight ratio of novaluron to Chortodonal Organ TRPV (vanilloid-type transient receptor potential) Channel Modulator insecticide is 5:1. The weight ratio of novaluron to Chortodonal Organ TRPV (vanilloid-type transient receptor potential) Channel Modulator insecticide may be an intermediate range selected from the above indicated ratios.

In one embodiment, the weight ratio of novaluron to afidopyropen in the composition is from about 1:100 to 100:1. In another embodiment, the weight ratio of novaluron to afidopyropen is from about 1:5 to 5:1. In a specific embodiment, the weight ratio of novaluron to afidopyropen is 1:5. In another specific embodiment, the weight ratio of novaluron to afidopyropen is 5:1. The weight ratio of novaluron to afidopyropen may be an intermediate range selected from the above indicated ratios.

In one embodiment, the weight ratio of novaluron to Arylisoxazolines, which are γ-aminobutyric acid (GABA)-gated chloride channel allosteric modulators insecticide in the composition is from about 1:100 to 100:1. In a specific embodiment, the weight ratio of novaluron to Arylisoxazolines, which are γ-aminobutyric acid (GABA)-gated chloride channel allosteric modulators insecticide is 1:1. The weight ratio of novaluron to Arylisoxazolines, which are γ-aminobutyric acid (GABA)-gated chloride channel allosteric modulators insecticide may be an intermediate range selected from the above indicated ratios.

In one embodiment, the weight ratio of novaluron to Isocycloseram in the composition is from about 1:100 to 100:1. In a specific embodiment, the weight ratio of novaluron to Isocycloseram is 1:1. The weight ratio of novaluron to Isocycloseram may be an intermediate range selected from the above indicated ratios.

In one embodiment, the weight ratio of novaluron to Meta-diamides, which are GABA-gated chloride channel allosteric modulators insecticide in the composition is from about 1:100 to 100:1. In another embodiment, the weight ratio of novaluron to Meta-diamides, which are GABA-gated chloride channel allosteric modulators insecticide is from about 1:1 to 10:1. In a specific embodiment, the weight ratio of novaluron to Meta-diamides, which are GABA-gated chloride channel allosteric modulators insecticide is 1:1. In another specific embodiment, the weight ratio of novaluron to Meta-diamides, which are GABA-gated chloride channel allosteric modulators insecticide is 2.5:1. In another specific embodiment, the weight ratio of novaluron to Meta-diamides, which are GABA-gated chloride channel allosteric modulators insecticide is 10:1. The weight ratio of novaluron to Meta-diamides, which are GABA-gated chloride channel allosteric modulators insecticide may be an intermediate range selected from the above indicated ratios.

In one embodiment, the weight ratio of novaluron to Broflanilide in the composition is from about 1:100 to 100:1. In another embodiment, the weight ratio of novaluron to Broflanilide is from about 1:1 to 10:1. In a specific embodiment, the weight ratio of novaluron to Broflanilide is 1:1. In another specific embodiment, the weight ratio of novaluron to Broflanilide is 2.5:1. In another specific embodiment, the weight ratio of novaluron to Broflanilide is 10:1. The weight ratio of novaluron to Broflanilide may be an intermediate range selected from the above indicated ratios.

In one embodiment, the weight ratio of novaluron to diamides, which are highly specific Ryanodin receptor (RyR) modulators insecticide in the composition is from about 1:100 to 100:1. In another embodiment, the weight ratio of novaluron to diamides, which are highly specific Ryanodin receptor (RyR) modulators insecticide is from about 1:25 to 25:1. In a specific embodiment, the weight ratio of novaluron to diamides, which are highly specific Ryanodin receptor (RyR) modulators insecticide is 1:1. In another specific embodiment, the weight ratio of novaluron to diamides, which are highly specific Ryanodin receptor (RyR) modulators insecticide is 2.5:1. In another specific embodiment, the weight ratio of novaluron to diamides, which are highly specific Ryanodin receptor (RyR) modulators insecticide is 25:1. In another specific embodiment, the weight ratio of novaluron to diamides, which are highly specific Ryanodin receptor (RyR) modulators insecticide is 5:1. In another specific embodiment, the weight ratio of novaluron to diamides, which are highly specific Ryanodin receptor (RyR) modulators insecticide is 1:5. The weight ratio of novaluron to diamides, which are highly specific Ryanodin receptor (RyR) modulators insecticide may be an intermediate range selected from the above indicated ratios.

In one embodiment, the weight ratio of novaluron to Tetraniliprole in the composition is from about 1:100 to 100:1. In another embodiment, the weight ratio of novaluron to Tetraniliprole is from about 1:25 to 25:1. In a specific embodiment, the weight ratio of novaluron to Tetraniliprole is 1:1. In another specific embodiment, the weight ratio of novaluron to Tetraniliprole is 2.5:1. In another specific embodiment, the weight ratio of novaluron to Tetraniliprole is 25:1. In another specific embodiment, the weight ratio of novaluron to Tetraniliprole is 5:1. In another specific embodiment, the weight ratio of novaluron to Tetraniliprole is 1:5. The weight ratio of novaluron to Tetraniliprole may be an intermediate range selected from the above indicated ratios.

In one embodiment, the weight ratio of novaluron to mesoionic pyrido[1,2-α]pyrimidinones insecticide in the composition is from about 1:100 to 100:1. In a specific embodiment, the weight ratio of novaluron to mesoionic pyrido[1,2-α]pyrimidinones insecticide is 1:1. The weight ratio of novaluron to mesoionic pyrido[1,2-α]pyrimidinones insecticide may be an intermediate range selected from the above indicated ratios.

In one embodiment, the weight ratio of novaluron to Dicloromezotiaz in the composition is from about 1:100 to 100:1. In a specific embodiment, the weight ratio of novaluron to Dicloromezotiaz is 1:1. The weight ratio of novaluron to Dicloromezotiaz may be an intermediate range selected from the above indicated ratios.

In one embodiment, the weight ratio of novaluron to chemotype insecticide in the composition is from about 1:100 to 100:1. In a specific embodiment, the weight ratio of novaluron to chemotype insecticide is 1:1. The weight ratio of novaluron to chemotype insecticide may be an intermediate range selected from the above indicated ratios.

In one embodiment, the weight ratio of novaluron to Flupyrimin in the composition is from about 1:100 to 100:1. In a specific embodiment, the weight ratio of novaluron to Flupyrimin is 1:1.

The weight ratio of novaluron to Flupyrimin may be an intermediate range selected from the above indicated ratios.

In one embodiment, the weight ratio of novaluron to organofluorine compound in the composition is from about 1:100 to 100:1. In a specific embodiment, the weight ratio of novaluron to organofluorine compound is 1:1. The weight ratio of novaluron to organofluorine compound may be an intermediate range selected from the above indicated ratios.

In one embodiment, the weight ratio of novaluron to Tyclopyrazoflor in the composition is from about 1:100 to 100:1. In a specific embodiment, the weight ratio of novaluron to Tyclopyrazoflor is 1:1. The weight ratio of novaluron to Tyclopyrazoflor may be an intermediate range selected from the above indicated ratios.

In one embodiment, the weight ratio of novaluron to Pyrrole compound in the composition is from about 1:100 to 100:1. In another embodiment, the weight ratio of novaluron to Pyrrole compound is from about 1:50 to 50:1. In a specific embodiment, the weight ratio of novaluron to Pyrrole compound is 1:1. In another specific embodiment, the weight ratio of novaluron to Pyrrole compound is 1:10. In another specific embodiment, the weight ratio of novaluron to Pyrrole compound is 50:1. The weight ratio of novaluron to Pyrrole compound may be an intermediate range selected from the above indicated ratios.

In one embodiment, the weight ratio of novaluron to Chlorfenapyr in the composition is from about 1:100 to 100:1. In another embodiment, the weight ratio of novaluron to Chlorfenapyr is from about 1:50 to 50:1. In a specific embodiment, the weight ratio of novaluron to Chlorfenapyr is 1:1. In another specific embodiment, the weight ratio of novaluron to Chlorfenapyr is 1:10. In another specific embodiment, the weight ratio of novaluron to Chlorfenapyr is 50:1. The weight ratio of novaluron to Chlorfenapyr may be an intermediate range selected from the above indicated ratios.

In one embodiment, the weight ratio of novaluron to sulfoximine compound in the composition is from about 1:100 to 100:1. In another embodiment, the weight ratio of novaluron to sulfoximine compound is from about 1:5 to 100:1. In a specific embodiment, the weight ratio of novaluron to sulfoximine compound is 1:5. In another specific embodiment, the weight ratio of novaluron to sulfoximine compound is 100:1. The weight ratio of novaluron to sulfoximine compound may be an intermediate range selected from the above indicated ratios.

In one embodiment, the weight ratio of novaluron to Sulfoxaflor in the composition is from about 1:100 to 100:1. In another embodiment, the weight ratio of novaluron to Sulfoxaflor is from about 1:5 to 100:1. In a specific embodiment, the weight ratio of novaluron to Sulfoxaflor is 1:5. In another specific embodiment, the weight ratio of novaluron to Sulfoxaflor is 100:1. The weight ratio of novaluron to Sulfoxaflor may be an intermediate range selected from the above indicated ratios.

In one embodiment, the weight ratio of novaluron to furanicotinyl compound in the composition is from about 1:100 to 100:1. In a specific embodiment, the weight ratio of novaluron to furanicotinyl compound is 1:1. The weight ratio of novaluron to furanicotinyl compound may be an intermediate range selected from the above indicated ratios.

In one embodiment, the weight ratio of novaluron to Dinotefuran in the composition is from about 1:100 to 100:1. In a specific embodiment, the weight ratio of novaluron to Dinotefuran is 1:1. The weight ratio of novaluron to Dinotefuran may be an intermediate range selected from the above indicated ratios.

In one embodiment, the weight ratio of novaluron to organophosphate compound in the composition is from about 1:100 to 100:1. In a specific embodiment, the weight ratio of novaluron to organophosphate compound is 1:1. In a specific embodiment, the weight ratio of novaluron to organophosphate compound is 1:10. The weight ratio of novaluron to organophosphate compound may be an intermediate range selected from the above indicated ratios.

In one embodiment, the weight ratio of novaluron to Acephate in the composition is from about 1:100 to 100:1. In a specific embodiment, the weight ratio of novaluron to Acephate is 1:10. The weight ratio of novaluron to Acephate may be an intermediate range selected from the above indicated ratios.

In one embodiment, the weight ratio of novaluron to Malathion in the composition is from about 1:100 to 100:1. In a specific embodiment, the weight ratio of novaluron to Malathion is 1:1. In a specific embodiment, the weight ratio of novaluron to Malathion is 1:10. The weight ratio of novaluron to Malathion may be an intermediate range selected from the above indicated ratios.

In one embodiment, the weight ratio of novaluron to foliar contact insecticide in the composition is from about 1:100 to 100:1. In a specific embodiment, the weight ratio of novaluron to foliar contact insecticide is 1:5. In a specific embodiment, the weight ratio of novaluron to foliar contact insecticide is 100:1. The weight ratio of novaluron to foliar contact insecticide may be an intermediate range selected from the above indicated ratios.

In one embodiment, the weight ratio of novaluron to foliar contact insecticide in the composition is from about 1:100 to 100:1. In a specific embodiment, the weight ratio of novaluron to foliar contact insecticide is 1:5. In a specific embodiment, the weight ratio of novaluron to foliar contact insecticide is 100:1. The weight ratio of novaluron to foliar contact insecticide may be an intermediate range selected from the above indicated ratios.

In one embodiment, the weight ratio of novaluron to Spiromesifen in the composition is from about 1:100 to 100:1. In a specific embodiment, the weight ratio of novaluron to Spiromesifen is 1:5. In a specific embodiment, the weight ratio of novaluron to Spiromesifen is 100:1. The weight ratio of novaluron to Spiromesifen may be an intermediate range selected from the above indicated ratios.

In one embodiment, the weight ratio of novaluron to phenylpyrazole chemical compound in the composition is from about 1:100 to 100:1. In another embodiment, the weight ratio of novaluron to phenylpyrazole chemical compound is from about 1:1 to 100:1. In another embodiment, the weight ratio of novaluron to phenylpyrazole chemical compound is from about 1:100 to 1:1. In another embodiment, the weight ratio of novaluron to phenylpyrazole chemical compound is from about 1:1 to 10:1. In a specific embodiment, the weight ratio of novaluron to phenylpyrazole chemical compound is 1:1. In another specific embodiment, the weight ratio of novaluron to phenylpyrazole chemical compound is 100:1. In another specific embodiment, the weight ratio of novaluron to phenylpyrazole chemical compound is 10:1. In another specific embodiment, the weight ratio of novaluron to phenylpyrazole chemical compound is 1:100. The weight ratio of novaluron to phenylpyrazole chemical compound may be an intermediate range selected from the above indicated ratios.

In one embodiment, the weight ratio of novaluron to Fipronil in the composition is from about 1:100 to 100:1. In another embodiment, the weight ratio of novaluron to Fipronil is from about 1:1 to 100:1. In another embodiment, the weight ratio of novaluron to Fipronil is from about 1:100 to 1:1. In another embodiment, the weight ratio of novaluron to Fipronil is from about 1:1 to 10:1. In a specific embodiment, the weight ratio of novaluron to Fipronil is 1:1. In another specific embodiment, the weight ratio of novaluron to Fipronil is 100:1. In another specific embodiment, the weight ratio of novaluron to Fipronil is 10:1. In another specific embodiment, the weight ratio of novaluron to Fipronil is 1:100. The weight ratio of novaluron to Fipronil may be an intermediate range selected from the above indicated ratios.

In one embodiment, the weight ratio of novaluron to Phenylpyrazole insecticide in the composition is from about 1:100 to 100:1. In a specific embodiment, the weight ratio of novaluron to Phenylpyrazole insecticide is 1:1. The weight ratio of novaluron to Phenylpyrazole insecticide may be an intermediate range selected from the above indicated ratios.

In one embodiment, the weight ratio of novaluron to Nicofluprole in the composition is from about 1:100 to 100:1. In a specific embodiment, the weight ratio of novaluron to Nicofluprole is 1:1. The weight ratio of novaluron to Nicofluprole may be an intermediate range selected from the above indicated ratios.

Application of the inventive compositions to plants may also lead to an increase in the crop yield.

The pesticidal mixture may be applied via in furrow spray, foliar application, broadcast, basal application, soil application, soil incorporation or soil injection. The pesticidal mixtures can be applied in the early stages of the crop cycle, such as for example pre-sowing or post-sowing of the crop.

In a further embodiment, the mixture is applied in non-crop areas which include but are not limited to, commercial areas, residential areas, lawns, ornamental plants, shrubs, trees, parks, livestock areas, warehouses, food storage facilities, grain bins, turfgrass, pastures, grasslands, rangelands, fallow land, rights-of-way, golf courses, parks, along roadsides, power-lines, pipelines, railways, forests, well sites, and equipment yards.

In yet another embodiment, the plants include vegetables, such as tomatoes, peppers, cabbage, broccoli, lettuce, spinach, cauliflower, cucurbits, melon, watermelon, cucumbers, carrots, onions, potatoes, tobacco, pome and stone fruits, walnuts, kiwi, berries, olive, almonds, pineapples, apples, pears, plums, peaches, and cherries, table and wine grapes, citrus fruit, such as oranges, lemons, grapefruits and limes, cotton, soybean, oil seed rape, tree nuts, wheat, barley, maize, sorghum, sunflower, peanuts, rice, pasture, corn, coffee, beans, peas, yucca, sugar cane, clover, chili and ornamentals such as roses.

In a further embodiment, the plants include cultivated plants which tolerate the action of herbicides, fungicides or insecticides as a result of breeding and/or genetically engineered methods.

In another embodiment, the insect pests are of the order Coleoptera, such as Acanthoscelides spp. (weevils), Acanthoscelides obtectus (common bean weevil), Agrilus planipennis (emerald ash borer), Agriotes spp. (wireworms), Anoplophora glabripennis (Asian longhorned beetle), Anthonomus spp. (weevils), Anthonomus grandis (boll weevil), Aphidius spp., Apion spp. (weevils), Apogonia spp. (grubs), Ataenius spretulus (Black Turgrass Ataenius), Atomaria linearis (pygmy mangold beetle), Aulacophore spp., Bothynoderes punctiventris (beet root weevil), Bruchus spp. (weevils), Bruchus pisorum (pea weevil), Cacoesia spp., Callosobruchus maculatus (southern cow pea weevil), Carpophilus hemipteras (dried fruit beetle), Cassida vittata, Cerosterna spp, Cerotoma spp. (chrysomeids), Cerotoma trifurcata (bean leaf beetle), Ceutorhynchus spp. (weevils), Ceutorhynchus assimilis (cabbage seedpod weevil), Ceutorhynchus napi (cabbage curculio), Chaetocnema spp. (chrysomelids), Colaspis spp. (soil beetles), Conoderus scalaris, Conoderus stigmosus, Conotrachelus nenuphar (plum curculio), Cotinus nitidis (Green June beetle), Crioceris asparagi (asparagus beetle), Cryptolestes ferrugineus (rusty grain beetle), Cryptolestes pusillus (flat grain beetle), Cryptolestes turcicus (Turkish grain beetle), Ctenicera spp. (wireworms), Curculio spp. (weevils), Cyclocephala spp. (grubs), Cylindrocpturus adspersus (sunflower stem weevil), Deporaus marginatus (mango leaf-cutting weevil), Dermestes lardarius (larder beetle), Dermestes maculates (hide beetle), Diabrotica spp. (chrysolemids), Epilachna varivestis (Mexican bean beetle), Faustinus cubae, Hylobius pales (pales weevil), Hypera spp. (weevils), Hypera postica (alfalfa weevil), Hyperdoes spp. (Hyperodes weevil), Hypothenemus hampei (coffee berry beetle), Ips spp. (engravers), Lasioderma serricorne (cigarette beetle), Leptinotarsa decemlineata (Colorado potato beetle), Liogenys futscus, Liogenys suturalis, Lissorhoptrus oryzophilus (rice water weevil), Lyctus spp. (wood beetles/powder post beetles), Maecolaspis joliveti, Megascelis spp., Melanotus communis, Meligethes spp., Meligethes aeneus (blossom beetle), Melolontha (common European cockchafer), Oberea brevis, Oberea linearis, Oryctes rhinoceros (date palm beetle), Oryzaephilus mercator (merchant grain beetle), Oryzaephilus surinamensis (sawtoothed grain beetle), Otiorhynchus spp. (weevils), Oulema melanopus (cereal leaf beetle), Oulema oryzae, Pantomorus spp. (weevils), Phyllophaga spp. (May/June beetle), Phyllophaga cuyabana, Phyllotreta spp. (chrysomelids), Phynchites spp., Popillia japonica (Japanese beetle), Prostephanus truncates (larger grain borer), Rhizopertha dominica (lesser grain borer), Rhizotrogus spp. (Eurpoean chafer), Rhynchophorus spp. (weevils), Scolytus spp. (wood beetles), Shenophorus spp. (Billbug), Sitona lineatus (pea leaf weevil), Sitophilus spp. (grain weevils), Sitophilus granaries (granary weevil), Sitophilus oryzae (rice weevil), Stegobium paniceum (drugstore beetle), Tribolium spp. (flour beetles), Tribolium castaneum (red flour beetle), Tribolium confusum (confused flour beetle), Trogoderma variabile (warehouse beetle) and Zabrus tenebioides.

In yet another embodiment, the insect pests are of the order Diptera, such as Aedes spp. (mosquitoes), Agromyza frontella (alfalfa blotch leafminer), Agromyza spp. (leaf miner flies), Anastrepha spp. (fruit flies), Anastrepha suspensa (Caribbean fruit fly), Anopheles spp. (mosquitoes), Batrocera spp. (fruit flies), Bactrocera cucurbitae (melon fly), Bactrocera dorsalis (oriental fruit fly), Ceratitis spp. (fruit flies), Ceratitis capitata (Mediterranean fruit fly), Chrysops spp. (deer flies), Cocliliomyia spp. (screwworms), Contarinia spp. (Gall midges), Culex spp. (mosquitoes), Dasineura spp. (gall midges), Dasineura brassicae (cabbage gall midge), Delia spp., Delia platura (seedcorn maggot), Drosophila spp. (vinegar flies), Fannia spp. (filth flies), Fannia canicularis (little house fly), Fannia scalaris (latrine fly), Gasterophilus intestinalis (horse bot fly), Gracillia perseae, Haematobia irritans (horn fly), Hylemyia spp. (root maggots), Hypoderma lineatum (common cattle grub), Liriomyza spp. (leafminer flies), Liriomyza brassica (serpentine leafminer), Melophagus ovinus (sheep ked), Musca spp. (muscid flies), Musca autumnalis (face fly), Musca domestica (house fly), Oestrus ovis (sheep bot fly), Oscinella frit (grass fly), Pegomyia betae (beet leafminer), Phorbia spp., Psila rosae (carrot rust fly), Rhagoletis cerasi (cherry fruit fly), Rhagoletis pomonella (apple maggot), Sitodiplosis mosellana (orange wheat blossom midge), Stomoxys calcitrans (stable fly), Tabanus spp. (horse flies) and Tipula spp. (crane flies).

In yet another embodiment, the insect pests are of the order Hemiptera, such as Acrosternum hilare (green stink bug), Blissus leucopterus (chinch bug), Calocoris norvegicus (potato mirid), Cimex hemipterus (tropical bed bug), Cimex lectularius (bed bug), Dagbertus fasciatus, Dichelops furcatus, Dysdercus suturellus (cotton stainer), Edessa meditabunda, Eurygaster maura (cereal bug), Euschistus heros, Euschistus servus (brown stink bug), Helopeltis antonii, Helopeltis theivora (tea blight plantbug), Lagynotomus spp. (stink bugs), Leptocorisa oratorius, Leptocorisa varicornis, Lygus spp. (plant bugs), Lygus hesperus (western tarnished plant bug), Maconellicoccus hirsutus, Neurocolpus longirostris, Nezara viridula (southern green stink bug), Paratrioza cockerelli, Phytocoris spp. (plant bugs), Phytocoris californicus, Phytocoris relativus, Piezodorus guildingi, Poecilocapsus lineatus (fourlined plant bug), Psallus vaccinicola, Pseudacysta perseae, Scaptocoris castanea and Triatoma spp. (bloodsucking conenose bugs/kissing bugs).

In yet another embodiment, the insect pests are of the order Homoptera, such as Acrythosiphon pisum (pea aphid), Adelges spp. (adelgids), Aleurodes proletella (cabbage whitefly), Aleurodicus disperses, Aleurothrixus floccosus (woolly whitefly), Aluacaspis spp., Amrasca bigutella, Aphrophora spp. (leafhoppers), Aonidiella aurantii (California red scale), Aphis spp. (aphids), Aphis gossypii (cotton aphid), Aphis pomi (apple aphid), Aulacorthum solani (foxglove aphid), Bemisia spp. (whiteflies), Bemisia argentifolii, Bemisia tabaci (sweetpotato whitefly), Brachycolus noxius (Russian aphid), Brachycorynella asparagi (asparagus aphid), Brevennia rehi, Brevicoryne brassicae (cabbage aphid), Ceroplastes spp. (scales), Ceroplastes rubens (red wax scale), Chionaspis spp. (scales), Chrysomphalus spp. (scales), Coccus spp. (scales), Dysaphis plantaginea (rosy apple aphid), Empoasca spp. (leafhoppers), Eriosoma lanigerum (woolly apple aphid), Icerya purchasi (cottony cushion scale), Idioscopus nitidulus (mango leafhopper), Laodelphax striatellus (smaller brown planthopper), Lepidosaphes spp., Macrosiphum spp., Macrosiphum euphorbiae (potato aphid), Macrosiphum granarium (English grain aphid), Macrosiphum rosae (rose aphid), Macrosteles quadrilineatus (aster leafhopper), Mahanarva frimbiolata, Metopolophium dirhodum (rose grain aphid), Mictis longicornis, Myzus persicae (green peach aphid), Nephotettix spp. (leafhoppers), Nephotettix cinctipes (green leafhopper), Nilaparvata lugens (brown planthopper), Parlatoria pergandii (chaff scale), Parlatoria ziziphi (ebony scale), Peregrinus maidis (corn delphacid), Philaenus spp. (spittlebugs), Phylloxera vitifoliae (grape phylloxera), Physokermes piceae (spruce bud scale), Planococcus spp. (mealybugs), Pseudococcus spp. (mealybugs), Pseudococcus brevipes (pine apple mealybug), Quadraspidiotus perniciosus (San Jose scale), Rhapalosiphum spp. (aphids), Rhapalosiphum maida (corn leaf aphid), Rhapalosiphum padi (oat bird-cherry aphid), Saissetia spp. (scales), Saissetia oleae (black scale), Schizaphis graminum (greenbug), Sitobion avenae (English grain aphid), Sogatella furcifera (white-backed planthopper), Therioaphis spp. (aphids), Toumeyella spp. (scales), Toxoptera spp. (aphids), Trialeurodes spp. (whiteflies), Trialeurodes vaporariorum (greenhouse whitefly), Trialeurodes abutiloneus (bandedwing whitefly), Unaspis spp. (scales), Unaspis yanonensis (arrowhead scale) and Zulia entreriana.

In yet another embodiment, the insect pests are of the order Lepidoptera, such as Achoea janata, Adoxophyes spp., Adoxophyes orana, Agrotis spp. (cutworms), Agrotis ipsilon (black cutworm), Alabama argillacea (cotton leafworm), Amorbia cuneana, Amyelosis transitella (navel orangeworm), Anacamptodes defectaria, Anarsia lineatella (peach twig borer), Anomis sabulifera (jute looper), Anticarsia gemmatalis (velvetbean caterpillar), Archips argyrospila (fruittree leafroller), Archips rosana (rose leaf roller), Argyrotaenia spp. (tortricid moths), Argyrotaenia citrana (orange tortrix), Autographa gamma, Bonagota cranaodes, Borbo cinnara (rice leaf folder), Bucculatrix thurberiella (cotton leafperforator), Caloptilia spp. (leaf miners), Capua reticulana, Carposina niponensis (peach fruit moth), Chilo spp., Chlumetia transversa (mango shoot borer), Choristoneura rosaceana (obliquebanded leafroller), Chrysodeixis spp., Cnaphalocerus medinalis (grass leafroller), Colias spp., Conpomorpha cramerella, Cossus (carpenter moth), Crambus spp. (Sod webworms), Cydia funebrana (plum fruit moth), Cydia molesta (oriental fruit moth), Cydia nignicana (pea moth), Cydia pomonella (codling moth), Darna diducta, Diaphania spp. (stem borers), Diatraea spp. (stalk borers), Diatraea saccharalis (sugarcane borer), Diatraea graniosella (southwester corn borer), Earias spp. (bollworms), Earias insulata (Egyptian bollworm), Earias vitella (rough northern bollworm), Ecdytopopha aurantianum, Elasmopalpus lignosellus (lesser cornstalk borer), Epiphysias postruttana (light brown apple moth), Ephestia spp. (flour moths), Ephestia cautella (almond moth), Ephestia elutella (tobbaco moth), Ephestia kuehniella (Mediterranean flour moth), Epimeces spp., Epinotia aporema, Erionota thrax (banana skipper), Eupoecilia ambiguella (grape berry moth), Euxoa auxiliaris (army cutworm), Feltia spp. (cutworms), Gortyna spp. (stemborers), Grapholita molesta (oriental fruit moth), Hedylepta indicata (bean leaf webber), Helicoverpa spp. (noctuid moths), Helicoverpa armigera (cotton bollworm), Helicoverpa zea (bollworm/corn earworm), Heliothis spp. (noctuid moths), Heliothis virescens (tobacco budworm), Hellula undalis (cabbage webworm), Indarbela spp. (root borers), Keiferia lycopersicella (tomato pinworm), Leucinodes orbonalis (eggplant fruit borer), Leucoptera malifoliella, Lithocollectis spp., Lobesia botrana (grape fruit moth), Loxagrotis spp. (noctuid moths), Loxagrotis albicosta (western bean cutworm), Lymantria dispar (gypsy moth), Lyonetia clerkella (apple leaf miner), Mahasena corbetti (oil palm bagworm), Malacosoma spp. (tent caterpillars), Mamestra brassicae (cabbage armyworm), Maruca testulalis (bean pod borer), Metisa plana (bagworm), Mythimna unipuncta (true armyworm), Neoleucinodes elegantalis (small tomato borer), Nymphula depunctalis (rice caseworm), Operophthera brumata (winter moth), Ostrinia nubilalis (European corn borer), Oxydia vesulia, Pandemis cerasana (common currant tortrix), Pandemis heparana (brown apple tortrix), Papilio demodocus, Pectinophora gossypiella (pink bollworm), Peridroma spp. (cutworms), Peridroma saucia (variegated cutworm), Perileucoptera coffeella (white coffee leafminer), Phthorimaea operculella (potato tuber moth), Phyllocnisitis citrella, Phyllonorycter spp. (leafminers), Pieris rapae (imported cabbageworm), Plathypena scabra, Plodia interpunctella (Indian meal moth), Plutella xylostella (diamondback moth), Polychrosis viteana (grape berry moth), Prays endocarpa, Prays oleae (olive moth), Pseudaletia spp. (noctuid moths), Pseudaletia unipunctata (armyworm), Pseudoplusia includens (soybean looper), Rachiplusia nu, Scirpophaga incertulas, Sesamia spp. (stemborers), Sesamia inferens (pink rice stem borer), Sesamia nonagrioides, Setora nitens, Sitotroga cerealella (Angoumois grain moth), Sparganothis pilleriana, Spodoptera spp. (armyworms), Spodoptera exigua (beet armyworm), Spodoptera littoralis (Egyptian cotton leafworm), Spodoptera frugiperda (fall armyworm), Spodoptera oridania (southern armyworm), Synanthedon spp. (root borers), Thecla basilides, Thermisia gemmatalis, Tineola bisselliella (webbing clothes moth), Trichoplusia ni (cabbage looper), Tuta absoluta, Yponomeuta spp., Zeuzera coffeae (red branch borer) and Zeuzera pyrina (leopard moth).

In yet another embodiment, the insect pests are of the order Orthoptera, such as Anabrus simplex (Mormon cricket), Gryllotalpidae (mole crickets), Locusta migratoria, Melanoplus spp. (grasshoppers), Microcentrum retinerve (angularwinged katydid), Pterophylla spp. (kaydids), chistocerca gregaria, Scudderia furcata (forktailed bush katydid) and Valanga nigricorni.

In yet another embodiment, the insect pests are of the order Thysanoptera, such as Frankliniella fusca (tobacco thrips), Frankliniella occidentalis (western flower thrips), Frankliniella shultzei Frankliniella williamsi (corn thrips), Heliothrips haemorrhaidalis (greenhouse thrips), Riphiphorothrips cruentatus, Scirtothrips spp., Scirtothrips citri (citrus thrips), Scirtothrips dorsalis (yellow tea thrips), Taeniothrips rhopalantennalis and Thrips spp.

In some embodiments, the insects include but not limited to Spidermites, Tetranychus urticae, Spodoptera spp, Helicoverpa spp., Aphis spp., Myzus spp., Bemisia tabaci, Trialurodes vaporariorum, Tuta absoluta, Halyomorpha halys, Drosophila spp., Frankliniella spp., Tetranichus spp. and Lygus spp.

The effective application rates of novaluron, and one of the active compounds as represented as compound II as defined above, cannot generally be defined, as it varies depending upon various conditions such as the type of the formulation, weather conditions, the type of crop and the type of pests.

The application rates of the combination on the field may vary, depending on the desired effect. In an embodiment, depending on the desired effect, the application rates of the mixture according to the invention are from 1 g ai/ha to 1000 g ai/ha, particularly from 1 to 500 g ai/ha, more particularly from 1 to 100 g ai/ha.

Correspondingly, the application rates for novaluron on the field are generally from 1 to 1000 g/ha. In some embodiments, the application rates for novaluron are generally from 1 to 500 g/ha, particularly from 1-100 g/ha.

Correspondingly, the application rates for one of the active compounds as represented as compound II as defined above, on the field are generally from 1 to 1000 g/ha. In some embodiments, the application rates for one of the active compounds as represented as compound II as defined above are generally from 1 to 500 g/ha, particularly from 1-100 g/ha,

The present subject matter further relates to a method of reducing the total amount of insecticidal active compounds necessary for controlling unwanted pests by a) applying novaluron at an application rate from about 25% to about 75% of the recommended application rate and b) applying one of the active compounds as represented as compound II as defined above.

That is, each of novaluron, and the active compounds as represented as compound II as defined above, may be applied jointly or in succession. In one example, novaluron and the active compounds as represented as compound II as defined above, are prepared separately, and the individual formulations are applied as is, or diluted to predetermined concentrations. In a further example, novaluron and the active compounds as represented as compound II as defined above, are prepared separately, and the formulations are mixed when diluted to a predetermined concentration. In another example, novaluron and one of the active compounds as represented as compound II as defined above, are formulated together, and the formulation is applied as it is, or the formulation is diluted to a predetermined concentration.

As merely representative example, novaluron and methoxyfenozide can be applied simultaneously, that is jointly or separately, or in succession, the sequence, in the case of separate application, generally not having any effect on the result of the control measures. In one example, novaluron and methoxyfenozide are prepared separately, and the individual formulations are applied as is, or diluted to predetermined concentrations. In a further example, novaluron and methoxyfenozide are prepared separately, and the formulations are mixed when diluted to a predetermined concentration. In another example, novaluron and methoxyfenozide are formulated together, and the formulation is applied as it is, or the formulation is diluted to a predetermined concentration.

In some embodiments, components of the mixture or composition of the present disclosure are applied at least one time during a growth season.

In some embodiments, the components of the mixture or composition of the present disclosure are applied two or more times during a growth season.

In some embodiments, the components of the mixture or composition of the present disclosure are applied as a soil application. In some embodiments, the mixtures or compositions described herein are applied as a foliar application. In some embodiments, the components of the mixture or the composition thereof are applied as seed treatment.

In some embodiments, the composition is a synergistic composition.

In yet another embodiment, the synergistic composition may be applied in various mixtures or combinations of novaluron, and one of the active compounds as represented as compound II as defined above, in a single “ready-for-use” form, or in a combined spray mixture composed from separate formulations of the single active ingredients, such as a “tank-mix” form.

In a further embodiment, the synergistic composition may be applied in various mixtures or combinations of novaluron and one of the active compounds as represented as compound II as defined above, in a single “ready-for-use” form, or in a combined spray mixture composed from separate formulations of the single active ingredients, such as a “tank-mix” form.

As merely representative example, the composition is applied in the form of a ready-for-use formulation comprising novaluron, and a diacylhydrazine insecticide (e.g. methoxyfenozide). This formulation can be obtained by combining the active ingredients in an effective amount with an agriculturally acceptable carrier, a surfactant or other application-promoting adjuvant customarily employed in formulation technology.

For a specific representative example, the composition of the present invention is preferably applied in the form of a ready-for-use formulation comprising novaluron and methoxyfenozide, which can be obtained by combining the two active ingredients with an agriculturally acceptable carrier, a surfactant or other application-promoting adjuvant customarily employed in formulation technology.

The present composition may be employed or prepared in any conventional form, for example, as wettable powders (WP), emulsion concentrates (EC), microemulsion concentrates (MEC), water-soluble powders (SP), water-soluble concentrates (SL), suspoemulsion (SE), oil dispersions (OD), concentrated emulsions (BW) such as oil-in-water and water-in-oil emulsions, sprayable solutions or emulsions, capsule suspensions (CS), suspension concentrates (SC), suspension concentrates, dusts (DP), oil-miscible solutions (OL), seed-dressing products, granules (GR) in the form of microgranules, spray granules, coated granules and absorption granules, granules for soil application or broadcasting, water-soluble granules (SG), water-dispersible granules (WDG), ULV formulations, microcapsules or waxes. These individual formulation types are known in the art.

According to an embodiment, the composition comprises at least one additional component selected from the group of surfactants, solid diluents and liquid diluents.

Such compositions can be formulated using agriculturally acceptable carriers, surfactants or other application-promoting adjuvants customarily employed in formulation technology and formulation techniques that are known in the art.

Examples of suitable liquid carriers potentially useful in the present compositions include but are not limited to water; aromatic hydrocarbons such as alkylbenzenes and alkylnaphthalenes; alcohols such as cyclohexanol, and decanol; ethylene glycol; polypropylene glycol; dipropropylene glycol; N,N-dimethylformamide; dimethylsulfoxide; dimethylacetamide; N-alkylpyrrolidones such as N-methyl-2-pyrrolidone; paraffins; various oils such as olive, castor, linseed, tung, sesame, corn, peanut, cotton-seed, soybean, rape-seed, or coconut oil; fatty acid esters; ketones such as cyclohexanone, 2-heptanone, isophorone, and 4-hydroxy-4-methyl-2-pentanone; and the like.

Examples of suitable solid carriers potentially useful in the present compositions include but are not limited to mineral earths such as silica gels, silicates, talc, kaolin, sericite, attaclay, limestone, bentonite, lime, chalk, bole, mirabilite, loess, clay, dolomite, zeolite, diatomaceous earth, calcium carbonate, calcium sulfate, magnesium sulfate, magnesium oxide, sodium carbonate and bicarbonate, and sodium sulfate; ground synthetic materials; fertilizers such as ammonium sulfate, ammonium phosphate, ammonium nitrate, ureas, and products of vegetable origin, such as cereal meal, tree bark meal, wood meal, and nutshell meal; cellulose powders; and other solid carriers.

Examples of suitable surfactants include, but are not limited to, non-ionic, anionic, cationic and ampholytic types such as alkoxylated fatty alcohols, ethoxylated polysorbate (e.g. tween 20), ethoxylated castor oil, lignin sulfonates, fatty acid sulfonates (e.g. lauryl sulfonate), phosphate esters such as phosphate esters of alcohol alkoxylates, phosphate esters of alkylphenol alkoxylates and phosphate esters of styrylphenol ethoxylates, condensates of sulfonated naphthalene and naphthalene derivatives with formaldehyde, condensates of naphthalene or of naphthalenesulfonic acid with phenol and formaldehyde, alkylarylsulfonates, ethoxylated alkylphenols and aryl phenols, polyalkylene glycols, sorbitol esters, alkali metal, sodium salts of lignosulphonates, tristyrylphenol ethoxylate phosphate esters, aliphatic alcohol ethoxylates, alkylphenol ethoxylates, ethylene oxide/propylene oxide block copolymers, graft copolymers and polyvinyl alcohol-vinyl acetate copolymers. Other surfactants known in the art may be used as desired.

Other ingredients, such as wetting agents, anti-foaming, adhesives, neutralizers, thickeners, binders, sequestrates, fertilizers, biocides, stabilizers, buffers or anti-freeze agents, may also be added to the present compositions in order to increase the stability, density, and viscosity of the described compositions.

Aqueous use forms can be prepared from emulsion concentrates, suspensions, pastes, wettable powders or water-dispersible granules by adding water. To prepare emulsions, pastes or oil dispersions, the components of the compositions either as such or dissolved in an oil or solvent, can be homogenized in water by means of a wetting agent, tackifier, dispersant or emulsifier. Alternatively, it is also possible to prepare concentrates comprising active ingredient, wetting agent, tackifier, dispersant or emulsifier and, if desired, a solvent or oil, which are suitable for dilution with water.

In some embodiments, the mixture, combination, composition or synergistic mixture or composition comprises one or more additional active ingredient(s). In some embodiments, the mixture or synergistic mixture comprises one or more additional non-active ingredient(s).

The present composition may include additional crop protection agents, for example insecticides, herbicides, fungicides, bactericides, nematicides, molluscicides, growth regulators, biological agents, fertilizers, or mixtures thereof. However, for the avoidance of doubt it is understood that such additional crop protection agents are unnecessary to achieve the desired control of pests as achieved by the present combinations.

In another embodiment, the present invention provides a kit comprising a synergistic pesticidal composition as described herein, or components thereof. Such kits may comprise, in addition to the aforementioned active components, one or more additional active and/or inactive ingredients, either within the provided pesticidal composition or separately.

As noted above, the compositions, kits and methods described herein exhibit a synergistic effect. A synergistic effect exists wherever the action of a combination of active components is greater than the sum of the action of each of the components alone. Therefore, a synergistically effective amount (or an effective amount of a synergistic composition or combination) is an amount that exhibits greater pesticidal activity than the sum of the activities of the individual components.

### Method of Use

The present invention provides a method for control of insects by contacting the insect or their food supply, habitat, breeding grounds or their locus with an effective amount of any one of the mixtures or the compositions disclosed herein so as to thereby control insects.

In an embodiment, this invention provides a method for controlling the insect, T. absoluta by contacting the insect or their food supply, habitat, breeding grounds or their locus with an effective amount of a synergistic mixture of novaluron and a Diacylhydrazine insecticide in a ratio from 1:100 to 100:1, so as to thereby controlling the said insect.

In an embodiment, this invention provides a method for controlling the insect, T. absoluta by contacting the insect or their food supply, habitat, breeding grounds or their locus with an effective amount of a synergistic mixture of novaluron and Methoxyfenozide in a ratio from 1:100 to 100:1, so as to thereby controlling the said insect.

In an embodiment, this invention provides a method for controlling the insect, T. absoluta by contacting the insect or their food supply, habitat, breeding grounds or their locus with an effective amount of a synergistic mixture of novaluron and Methoxyfenozide in a ratio from 1:1 to 100:1, so as to thereby controlling the said insect.

In an embodiment, this invention provides a method for controlling the insect, T. absoluta by contacting the insect or their food supply, habitat, breeding grounds or their locus with an effective amount of a synergistic mixture of novaluron and a Spinosyns insecticide in a ratio from 1:100 to 100:1, so as to thereby controlling the said insect.

In an embodiment, this invention provides a method for controlling the insect, T. absoluta by contacting the insect or their food supply, habitat, breeding grounds or their locus with an effective amount of a synergistic mixture of novaluron and Spinetoram in a ratio from 1:100 to 100:1, so as to thereby controlling the said insect.

In an embodiment, this invention provides a method for controlling the insect, T. absoluta by contacting the insect or their food supply, habitat, breeding grounds or their locus with an effective amount of a synergistic mixture of novaluron and Spinetoram in a ratio of 1:100, so as to thereby controlling the said insect.

In an embodiment, this invention provides a method for controlling the insect, T. absoluta by contacting the insect or their food supply, habitat, breeding grounds or their locus with an effective amount of a synergistic mixture of novaluron and Spinetoram in a ratio of 100:1, so as to thereby controlling the said insect.

In an embodiment, this invention provides a method for controlling the insect, T. absoluta by contacting the insect or their food supply, habitat, breeding grounds or their locus with an effective amount of a synergistic mixture of novaluron and Spinetoram in a ratio of 1:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and a Diacylhydrazine insecticide in a ratio from 1:100 to 100:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and Methoxyfenozid in a ratio from 1:100 to 100:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and Methoxyfenozid in a ratio of 1:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and a Spinosyns insecticide in a ratio from 1:100 to 100:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and Spinetoram in a ratio from 1:100 to 100:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and Spinetoram in a ratio from 1:5 to 5:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and one of arylisoxazolines, which are γ-aminobutyric acid (GABA)-gated chloride channel allosteric modulators insecticide in a ratio from 1:100 to 100:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and Isocycloseram in a ratio from 1:100 to 100:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and Isocycloseram in a ratio of 1:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and one of diamides, which are highly specific Ryanodin receptor (RyR) modulators insecticide in a ratio from 1:100 to 100:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and Tetraniliprole in a ratio from 1:100 to 100:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and Tetraniliprole in a ratio from 1:5 to 5:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and one of mesoionic pyrido[1,2-α]pyrimidinones insecticide in a ratio from 1:100 to 100:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and Dicloromezotiaz in a ratio from 1:100 to 100:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and Dicloromezotiaz in a ratio of 1:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and chemotype insecticide in a ratio from 1:100 to 100:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and Flupyrimin in a ratio from 1:100 to 100:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and Flupyrimin in a ratio of 1:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and organofluorine compound in a ratio from 1:100 to 100:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and Tyclopyrazoflor in a ratio from 1:100 to 100:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and Tyclopyrazoflor in a ratio of 1:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and furanicotinyl compound in a ratio from 1:100 to 100:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and Dinotefuran in a ratio from 1:100 to 100:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and Dinotefuran in a ratio of 1:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and phenylpyrazole chemical compound in a ratio from 1:100 to 100:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and Fipronil in a ratio from 1:100 to 100:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and Fipronil in a ratio from 1:1 to 100:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and Phenylpyrazole insecticide in a ratio from 1:100 to 100:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and Nicofluprole in a ratio from 1:100 to 100:1, so as to thereby controlling the said insect.

In an embodiment, this invention provides a method for controlling the insect, S. littoralis by contacting the insect or their food supply, habitat, breeding grounds or their locus with an effective amount of a synergistic mixture of novaluron and Nicofluprole in a ratio of 1:1, so as to thereby controlling the said insect.

In an embodiment, this invention provides a method for controlling the insect, F. occidentalis by contacting the insect or their food supply, habitat, breeding grounds or their locus with an effective amount of a synergistic mixture of novaluron and Spinosyns insecticide in a ratio from 1:100 to 100:1, so as to thereby controlling the said insect.

In an embodiment, this invention provides a method for controlling the insect, F. occidentalis by contacting the insect or their food supply, habitat, breeding grounds or their locus with an effective amount of a synergistic mixture of novaluron and Spinosad in a ratio from 1:100 to 100:1, so as to thereby controlling the said insect.

In an embodiment, this invention provides a method for controlling the insect, F. occidentalis by contacting the insect or their food supply, habitat, breeding grounds or their locus with an effective amount of a synergistic mixture of novaluron and Spinosad in a ratio from 1:1 to 100:1, so as to thereby controlling the said insect.

In an embodiment, this invention provides a method for controlling the insect, F. occidentalis by contacting the insect or their food supply, habitat, breeding grounds or their locus with an effective amount of a synergistic mixture of novaluron and Spinetoram in a ratio from 1:100 to 100:1, so as to thereby controlling the said insect.

In an embodiment, this invention provides a method for controlling the insect, F. occidentalis by contacting the insect or their food supply, habitat, breeding grounds or their locus with an effective amount of a synergistic mixture of novaluron and Spinetoram in a ratio from 1:1 to 100:1, so as to thereby controlling the said insect.

In an embodiment, this invention provides a method for controlling the insect, F. occidentalis by contacting the insect or their food supply, habitat, breeding grounds or their locus with an effective amount of a synergistic mixture of novaluron and organophosphate compound insecticide in a ratio from 1:100 to 100:1, so as to thereby controlling the said insect.

In an embodiment, this invention provides a method for controlling the insect, F. occidentalis by contacting the insect or their food supply, habitat, breeding grounds or their locus with an effective amount of a synergistic mixture of novaluron and Malathion in a ratio from 1:100 to 100:1, so as to thereby controlling the said insect.

In an embodiment, this invention provides a method for controlling the insect, F. occidentalis by contacting the insect or their food supply, habitat, breeding grounds or their locus with an effective amount of a synergistic mixture of novaluron and Malathion in a ratio of 1:1, so as to thereby controlling the said insect.

In an embodiment, this invention provides a method for controlling the insect, F. occidentalis by contacting the insect or their food supply, habitat, breeding grounds or their locus with an effective amount of a synergistic mixture of novaluron and phenylpyrazole chemical compound insecticide in a ratio from 1:100 to 100:1, so as to thereby controlling the said insect.

In an embodiment, this invention provides a method for controlling the insect, F. occidentalis by contacting the insect or their food supply, habitat, breeding grounds or their locus with an effective amount of a synergistic mixture of novaluron and Fipronil in a ratio from 1:100 to 100:1, so as to thereby controlling the said insect.

In an embodiment, this invention provides a method for controlling the insect, S. frugiperda by contacting the insect or their food supply, habitat, breeding grounds or their locus with an effective amount of a synergistic mixture of novaluron and Spinosyns insecticide in a ratio from 1:100 to 100:1, so as to thereby controlling the said insect.

In an embodiment, this invention provides a method for controlling the insect, S. frugiperda by contacting the insect or their food supply, habitat, breeding grounds or their locus with an effective amount of a synergistic mixture of novaluron and Spinetoram in a ratio from 1:100 to 100:1, so as to thereby controlling the said insect.

In an embodiment, this invention provides a method for controlling the insect, S. frugiperda by contacting the insect or their food supply, habitat, breeding grounds or their locus with an effective amount of a synergistic mixture of novaluron and Spinetoram in a ratio from 1:5 to 5:1, so as to thereby controlling the said insect.

In an embodiment, this invention provides a method for controlling the insect, S. frugiperda by contacting the insect or their food supply, habitat, breeding grounds or their locus with an effective amount of a synergistic mixture of novaluron and one of Meta-diamides, which are GABA-gated chloride channel allosteric modulators insecticide in a ratio from 1:100 to 100:1, so as to thereby controlling the said insect.

In an embodiment, this invention provides a method for controlling the insect, S. frugiperda by contacting the insect or their food supply, habitat, breeding grounds or their locus with an effective amount of a synergistic mixture of novaluron and Broflanilide in a ratio from 1:100 to 100:1, so as to thereby controlling the said insect.

In an embodiment, this invention provides a method for controlling the insect, S. frugiperda by contacting the insect or their food supply, habitat, breeding grounds or their locus with an effective amount of a synergistic mixture of novaluron and Broflanilide in a ratio from 1:1 to 10:1, so as to thereby controlling the said insect.

In an embodiment, this invention provides a method for controlling the insect, S. frugiperda by contacting the insect or their food supply, habitat, breeding grounds or their locus with an effective amount of a synergistic mixture of novaluron and one of diamides, which are highly specific Ryanodin receptor (RyR) modulators insecticide in a ratio from 1:100 to 100:1, so as to thereby controlling the said insect.

In an embodiment, this invention provides a method for controlling the insect, S. frugiperda by contacting the insect or their food supply, habitat, breeding grounds or their locus with an effective amount of a synergistic mixture of novaluron and Tetraniliprole in a ratio from 1:100 to 100:1, so as to thereby controlling the said insect.

In an embodiment, this invention provides a method for controlling the insect, S. frugiperda by contacting the insect or their food supply, habitat, breeding grounds or their locus with an effective amount of a synergistic mixture of novaluron and Tetraniliprole in a ratio from 2.5:1 to 25:1, so as to thereby controlling the said insect.

In an embodiment, this invention provides a method for controlling the insect, M. persicae by contacting the insect or their food supply, habitat, breeding grounds or their locus with an effective amount of a synergistic mixture of novaluron and one of acetyl CoA carboxylase (ACC) inhibitor insecticide in a ratio from 1:100 to 100:1, so as to thereby controlling the said insect.

In an embodiment, this invention provides a method for controlling the insect, M. persicae by contacting the insect or their food supply, habitat, breeding grounds or their locus with an effective amount of a synergistic mixture of novaluron and Spirotetramat in a ratio from 1:100 to 100:1, so as to thereby controlling the said insect.

In an embodiment, this invention provides a method for controlling the insect, M. persicae by contacting the insect or their food supply, habitat, breeding grounds or their locus with an effective amount of a synergistic mixture of novaluron and Spirotetramat in a ratio of 1:100, so as to thereby controlling the said insect.

In an embodiment, this invention provides a method for controlling the insect, M. persicae by contacting the insect or their food supply, habitat, breeding grounds or their locus with an effective amount of a synergistic mixture of novaluron and sulfoximine compound insecticide in a ratio from 1:100 to 100:1, so as to thereby controlling the said insect.

In an embodiment, this invention provides a method for controlling the insect, M. persicae by contacting the insect or their food supply, habitat, breeding grounds or their locus with an effective amount of a synergistic mixture of novaluron and Sulfoxaflor in a ratio from 1:100 to 100:1, so as to thereby controlling the said insect.

In an embodiment, this invention provides a method for controlling the insect, M. persicae by contacting the insect or their food supply, habitat, breeding grounds or their locus with an effective amount of a synergistic mixture of novaluron and Sulfoxaflor in a ratio from 1:5 to 100:1, so as to thereby controlling the said insect.

In an embodiment, this invention provides a method for controlling the insect, M. persicae by contacting the insect or their food supply, habitat, breeding grounds or their locus with an effective amount of a synergistic mixture of novaluron and organophosphate compound insecticide in a ratio from 1:100 to 100:1, so as to thereby controlling the said insect.

In an embodiment, this invention provides a method for controlling the insect, M. persicae by contacting the insect or their food supply, habitat, breeding grounds or their locus with an effective amount of a synergistic mixture of novaluron and Acephate in a ratio from 1:100 to 100:1, so as to thereby controlling the said insect.

In an embodiment, this invention provides a method for controlling the insect, M. persicae by contacting the insect or their food supply, habitat, breeding grounds or their locus with an effective amount of a synergistic mixture of novaluron and Acephate in a ratio of 1:10, so as to thereby controlling the said insect.

In an embodiment, this invention provides a method for controlling the insect, M. persicae by contacting the insect or their food supply, habitat, breeding grounds or their locus with an effective amount of a synergistic mixture of novaluron and foliar contact insecticide in a ratio from 1:100 to 100:1, so as to thereby controlling the said insect.

In an embodiment, this invention provides a method for controlling the insect, M. persicae by contacting the insect or their food supply, habitat, breeding grounds or their locus with an effective amount of a synergistic mixture of novaluron and Spiromesifen in a ratio from 1:100 to 100:1, so as to thereby controlling the said insect.

In an embodiment, this invention provides a method for controlling the insect, M. persicae by contacting the insect or their food supply, habitat, breeding grounds or their locus with an effective amount of a synergistic mixture of novaluron and Spiromesifen in a ratio of 100:1, so as to thereby controlling the said insect.

In an embodiment, this invention provides a method for controlling the insect, T. urticae by contacting the insect or their food supply, habitat, breeding grounds or their locus with an effective amount of a synergistic mixture of novaluron and one of acetyl COA carboxylase (ACC) inhibitors insecticide in a ratio from 1:100 to 100:1, so as to thereby controlling the said insect.

In an embodiment, this invention provides a method for controlling the insect, T. urticae by contacting the insect or their food supply, habitat, breeding grounds or their locus with an effective amount of a synergistic mixture of novaluron and Spirotetramat in a ratio from 1:100 to 100:1, so as to thereby controlling the said insect.

In an embodiment, this invention provides a method for controlling the insect, T. urticae by contacting the insect or their food supply, habitat, breeding grounds or their locus with an effective amount of a synergistic mixture of novaluron and Spirotetramat in a ratio from 1:100 to 1:1, so as to thereby controlling the said insect.

In an embodiment, this invention provides a method for controlling the insect, T. urticae by contacting the insect or their food supply, habitat, breeding grounds or their locus with an effective amount of a synergistic mixture of novaluron and Pyrrole compound insecticide in a ratio from 1:100 to 100:1, so as to thereby controlling the said insect.

In an embodiment, this invention provides a method for controlling the insect, T. urticae by contacting the insect or their food supply, habitat, breeding grounds or their locus with an effective amount of a synergistic mixture of novaluron and Chlorfenapyr in a ratio from 1:100 to 100:1, so as to thereby controlling the said insect.

In an embodiment, this invention provides a method for controlling the insect, T. urticae by contacting the insect or their food supply, habitat, breeding grounds or their locus with an effective amount of a synergistic mixture of novaluron and Chlorfenapyr in a ratio from 1:10 to 50:1, so as to thereby controlling the said insect.

In an embodiment, this invention provides a method for controlling the insect, B. tabaci by contacting the insect or their food supply, habitat, breeding grounds or their locus with an effective amount of a synergistic mixture of novaluron and Chortodonal Organ TRPV (vanilloid-type transient receptor potential) Channel Modulator insecticide in a ratio from 1:100 to 100:1, so as to thereby controlling the said insect.

In an embodiment, this invention provides a method for controlling the insect, B. tabaci by contacting the insect or their food supply, habitat, breeding grounds or their locus with an effective amount of a synergistic mixture of novaluron and afidopyropen in a ratio from 1:100 to 100:1, so as to thereby controlling the said insect.

In an embodiment, this invention provides a method for controlling the insect, B. tabaci by contacting the insect or their food supply, habitat, breeding grounds or their locus with an effective amount of a synergistic mixture of novaluron and afidopyropen in a ratio from 1:5 to 5:1, so as to thereby controlling the said insect.

In an embodiment, this invention provides a method for controlling the insect, A. gossyppii by contacting the insect or their food supply, habitat, breeding grounds or their locus with an effective amount of a synergistic mixture of novaluron and organophosphate compound insecticide in a ratio from 1:100 to 100:1, so as to thereby controlling the said insect.

In an embodiment, this invention provides a method for controlling the insect, A. gossyppii by contacting the insect or their food supply, habitat, breeding grounds or their locus with an effective amount of a synergistic mixture of novaluron and Malathion in a ratio from 1:100 to 100:1, so as to thereby controlling the said insect.

In an embodiment, this invention provides a method for controlling the insect, A. gossyppii by contacting the insect or their food supply, habitat, breeding grounds or their locus with an effective amount of a synergistic mixture of novaluron and Malathion in a ratio of 1:10, so as to thereby controlling the said insect.

In an embodiment, this invention provides a method for controlling the insect, A. gossyppii by contacting the insect or their food supply, habitat, breeding grounds or their locus with an effective amount of a synergistic mixture of novaluron and foliar contact insecticide in a ratio from 1:100 to 100:1, so as to thereby controlling the said insect.

In an embodiment, this invention provides a method for controlling the insect, A. gossyppii by contacting the insect or their food supply, habitat, breeding grounds or their locus with an effective amount of a synergistic mixture of novaluron and Spiromesifen in a ratio from 1:100 to 100:1, so as to thereby controlling the said insect.

In an embodiment, this invention provides a method for controlling the insect, A. gossyppii by contacting the insect or their food supply, habitat, breeding grounds or their locus with an effective amount of a synergistic mixture of novaluron and Spiromesifen in a ratio of 1:5, so as to thereby controlling the said insect.

In an embodiment, this invention provides a method for controlling the insect, H. halys by contacting the insect or their food supply, habitat, breeding grounds or their locus with an effective amount of a synergistic mixture of novaluron and phenylpyrazole chemical compound insecticide in a ratio from 1:100 to 100:1, so as to thereby controlling the said insect.

In an embodiment, this invention provides a method for controlling the insect, H. halys by contacting the insect or their food supply, habitat, breeding grounds or their locus with an effective amount of a synergistic mixture of novaluron and Fipronil in a ratio from 1:100 to 100:1, so as to thereby controlling the said insect.

In an embodiment, this invention provides a method for controlling the insect, H. halys by contacting the insect or their food supply, habitat, breeding grounds or their locus with an effective amount of a synergistic mixture of novaluron and Fipronil in a ratio of 10:1, so as to thereby controlling the said insect.

The present invention provides a method of protecting plants from attack or infestation by insects comprising contacting the plant, or the soil or water in which the plant is growing, with an effective amount of any one of the mixtures or the compositions disclosed herein so as to thereby protect plants from attack or infestation by insects.

The present invention provides a method of enhancing knock-down activity and/or prolonged control comprising contacting the plant, or the soil or water in which the plant is growing, with an effective amount of any one of the mixtures or the compositions disclosed herein so as to thereby enhance knock-down activity and/or prolonged control.

The present invention provides a method for increasing resistance to novaluron comprising contacting the plant, or the soil or water in which the plant is growing, with an effective amount of any one of the mixtures or the compositions disclosed herein so as to thereby increase resistance to novaluron.

The present invention provides a method for enhancing root systems and/or enhancing crop plants development and/or enhancing crop plants vigor and/or improving plant potential yield comprising applying an effective amount of any one of the mixtures or compositions disclosed herein to one or more plants, the locus thereof or propagation material thereof.

The present invention provides a method for enhancing plant development comprising applying an effective amount of any one of the mixtures or the compositions disclosed herein to one or more plants, the locus thereof or propagation material thereof so as to thereby enhance plant development.

The present invention provides a method for enhancing root system comprising applying an effective amount of any one of the mixtures or the compositions disclosed herein to one or more plants, the locus thereof or propagation material thereof so as to thereby enhance the root system.

The present invention provides a method for enhancing plant vigor comprising applying an effective amount of any one of the mixtures or the compositions disclosed herein to one or more plants, the locus thereof or propagation material thereof so as to thereby enhance plant vigor.

The present invention provides a method for improving plant potential yield comprising applying an effective amount of any one of the mixtures or the compositions disclosed herein to one or more plants, the locus thereof or propagation material thereof so as to thereby improve plant potential yield.

The present invention provides a method for regulating plant growth comprising applying an effective amount of any one of the mixtures or the compositions disclosed herein to one or more plants, the locus thereof or propagation material thereof so as to thereby regulate plant growth.

The present invention also provides a method for enhancing plant growth comprising applying an effective amount of any one of the mixtures and/or compositions disclosed herein to one or more plants, the locus thereof or propagation material thereof.

In some embodiments, the mixtures and formulations of the present invention are applied as a knock-down treatment.

In some embodiments, the mixtures and formulations of the present invention are applied to provide prolonged insecticidal control.

The following examples illustrate the practice of the present invention in some of its embodiments but should not be construed as limiting the scope of the invention. Other embodiments will be apparent to one skilled in the art from consideration of the specification and examples. It is intended that the specification, including the examples, is considered exemplary only without limiting the scope and spirit of the invention.

### EXAMPLES

A synergistic effect exists whenever the action of a combination of active ingredients is greater than the sum of the action of each of the ingredients alone. Therefore, a synergistic combination is a combination of active ingredients having an action that is greater than the sum of the action of each active ingredient alone, and a synergistically effective amount is an effective amount of a synergistic combination.

Colby's method is used to determine if synergy exists for a combination of active ingredients. According to Colby, the expected action (E) of active ingredients A+B is:

$$E = A + B - ( \frac{A B}{100} )$$

where E=expected efficacy, A and B=the efficacy of two active ingredients A and B at a given dose.

When the percentage of control observed (O) for the combination is greater than the expected (E) percentage, there is a synergistic effect. The synergism ratio (R) is calculated as the ratio between the expected values and observed values. If the synergism ratio (R) between observed and expected is >1 then synergy is exhibited, if R=1 then the effect is additive and if R<1 then the mix is antagonistic.

For a more detailed description of the Colby formula, see Colby, S. R. “Calculating synergistic and antagonistic responses of herbicide combination,” Weeds, Vol. 15, pages 20-22; 1967; see also Limpel et al., Proc. NEWCC 16: 48-53 (1962).

The insecticidal compounds A (Novaluron) and B (mix partner) are formulated as equivalent suspension concentrates to eliminate the effects of differing formulation inerts on biological activity. Efficacy of the insecticidal compositions is evaluated with reference to a scale of 0% to 100% in comparison with untreated control plots. 0 means no damage and 100 means complete destruction of the harmful pests.

A representative experiment was conducted to evaluate the insecticidal control of novaluron, a compound II, namely methoxyfenozide as well as a mixture of novaluron and methoxyfenozide against Spodoptera littoralis larvae.

The experiments were conducted by applying commercially available compositions of Novaluron (Rimon®) and methoxyfenozide (Runner®) alone or together. The compositions were diluted with water to the stated concentration of the active compound.

The following active ingredients and their mixtures were evaluated:
Novaluron: 0.01 mg a.i./liter
Methoxyfenozide: 0.01 mg a.i./liter
Novaluron+Methoxyfenozide 0.01 mg a.i./liter+0.01 mg a.i./liter

To evaluate the insecticidal control of novaluron and methoxyfenozide alone and in a binary mixture, castor bean leaves were treated with the above listed treatments. The treated leaves were exposed for 4-day feeding to 3^{rd}-instar Spodoptera littoralis and the larvae were exposed for additional 4 days on untreated leaves. Larval mortality was determined at day 4 and 8. The treatments were composed of 3-5 replicates of 10 larvae each.

Table 1 below summarizes the calculated synergy (Colby synergism ratio) for the mixture of novaluron and methoxyfenozide at each of the evaluation periods.

TABLE 1
Effect of tank mix of novaluron +
methoxyfenozide on control S. littoralis

| | Larval | | Larval | | | |
|---|---|---|---|---|---|---|
| | mortality, % | | mortality, % | | Synergism | |
| | (observed) | | (Expected) | | ratio (R) | |
| Compound | 4 d | 8 d | 4 d | 8 d | 4 d | 8 d |
| Control | 4.1 | 13.8 | | | | |
| Novaluron 0.01 mg a.i./L | 3.5 | 20 | | | | |
| Methoxyfenozide 0.01 mg a.i./L | 4.1 | 12.0 | | | | |
| Novaluron 0.01 mg a.i./L + | 52 | 70.4 | 7.5 | 29.6 | 7.0 | 2.4 |
| Methoxyfenozide 0.01 mg a.i./L | | | | | | |

The table above clearly shows that the observed activity of the active compound combination according to the invention is greater than the calculated activity, i.e. a synergistic effect is present.

Larval weight gain (LWG) was also measured in order to determine the effectiveness of the mixture of novaluron and methoxyfenozide when compared to the solo application of novaluron and methoxyfenozide.

Table 2 below also summarizes the calculated synergy (Colby ratio) for the mixture of novaluron and methoxyfenozide at each of the evaluation periods on another pest:

TABLE 2
Novaluron + Methoxyfenzide against T. absoluta,
Synergistic activity of a Novaluron + Methoxyfenzide
against T. absoluta, 72 hours after treatment

| | | Observed % | Expected % | Synergism |
|---|---|---|---|---|
| Active | Rate | control | control | ratio |
| ingredient | (ppm) | (O) | (E) | (R) |
| Novaluron | 300 | 0 | — | — |
| Methoxyfenzide | 3 | 16.7 | — | — |
| Novaluron + | 300 + 3 | 33.3 | 16.7 | 1.99 |
| Methoxyfenzide | | | | |

Table 3 below summarizes the larval weight gain (LWG) (compared to the control), that was determined 4 days after treatment for the mixture of novaluron and methoxyfenozide.

TABLE 3
Effect of tank mix of novaluron +
methoxyfenozide on LWG of S. littoralis

| | LWG |
|---|---|
| Compound | % rel. Control |
| Control | 100 |
| Novaluron 0.01 mg a.i./L | 108 |
| Methoxyfenozide 0.01 mg a.i./L | 93 |
| Novaluron 0.01 mg a.i./L + | 57 |
| Methoxyfenozide 0.01 mg a.i./L | |

As can be seen in Table 3, neither novaluron nor methoxyfenozide alone have any effect on the weight gain of the Spodoptera littoralis larvae. However, when novaluron and methoxyfenozide are combined the growth of the larvae is 57% less when compared to the growth of the larvae in control treatment. This indicates that, when combined, novaluron and methoxyfenozide have a greater effect on the feeding activity of the S. littoralis.

Likewise following experimentations were done on other mixtures of novaluron on various pests, the result of which are summarized in the below tables:

TABLE 4
Novaluron + Spinosad

| | | | | |
|---|---|---|---|---|
| | | | Expected | |
| | | Observed % | % control | Synergism ratio |
| Active ingredient | Rate (ppm) | control (O) | (E) | (R) |

A)
Synergistic activity of a Novaluron + Spinosad against F. occidentalis, 48 hours after treatment

| | | | | |
|---|---|---|---|---|
| Novaluron | 5.3 | 14.0 | — | — |
| Spinosad | 5.3 | 2.0 | — | — |
| Novaluron + Spinosad | 5.3 + 5.3 | 20.0 | 15.7 | 1.27 |

B)
Synergistic activity of a Novaluron + Spinosad against F. occidentalis, 72 hours after treatment

| | | | | |
|---|---|---|---|---|
| Novaluron | 5.3 | 20.0 | — | — |
| Spinosad | 5.3 | 4.0 | — | — |
| Spinosad | 530 | 32.0 | — | — |
| Novaluron + Spinosad | 5.3 + 5.3 | 32.0 | 23.2 | 1.38 |
| Novaluron + Spinosad | 5.3 + 530 | 48.0 | 45.6 | 1.05 |

C)
Synergistic activity of a Novaluron + Spinosad against F. occidentalis, 7 days after treatment

| | | | | |
|---|---|---|---|---|
| Novaluron | 5.3 | 40.0 | — | — |
| Spinosad | 5.3 | 32.0 | — | — |
| Spinosad | 530 | 60.0 | — | — |
| Novaluron + Spinosad | 5.3 + 5.3 | 60.0 | 59.2 | 1.01 |
| Novaluron + Spinosad | 5.3 + 530 | 92.0 | 76.0 | 1.21 |

TABLE 5
Novaluron + Spinetoram

| | | | | |
|---|---|---|---|---|
| | | Observed % | Expected % | Synergism ratio |
| Active ingredient | Rate (ppm) | control (O) | control (E) | (R) |

A)
Synergistic activity of a Novaluron + Spinetoram against S. frugiperda, 120 hours after treatment

| | | | | |
|---|---|---|---|---|
| Novaluron | 0.01 | 27 | — | — |
| Novaluron | 0.05 | 40 | — | — |
| Spinetoram | 0.01 | 20 | — | — |
| Spinetoram | 0.025 | 30 | — | — |
| Spinetoram | 0.05 | 45 | — | — |
| Novaluron + | 0.01 + 0.025 | 80 | 48.9 | 1.64 |
| Spinetoram | | | | |
| Novaluron + | 0.01 + 0.05 | 100 | 59.85 | 1.67 |
| Spinetoram | | | | |
| Novaluron + | 0.01 + 0.01 | 100 | 41.6 | 2.40 |
| Spinetoram | | | | |
| Novaluron + | 0.05 + 0.01 | 80 | 52 | 1.54 |
| Spinetoram | | | | |

B)
Synergistic activity of a Novaluron + Spinetoram against S. littoralis, 72 hours after treatment

| | | | | |
|---|---|---|---|---|
| Novaluron | 0.02 | 0 | — | — |
| Spinetoram | 0.1 | 80 | — | — |
| Spinetoram | 0.004 | 0 | — | — |
| Novaluron + | 0.02 + 0.1 | 82.5 | 80 | 1.03 |
| Spinetoram | | | | |
| Novaluron + | 0.02 + 0.004 | 7.5 | 0 | NA |
| Spinetoram | | | | |

C)
Synergistic activity of a Novaluron + Spinetoram against T. absoluta, 72 hours after treatment

| | | | | |
|---|---|---|---|---|
| Novaluron | 0.1 | 16.7 | — | — |
| Novaluron | 1 | 16.7 | — | — |
| Novaluron | 300 | 16.7 | — | — |
| Spinetoram | 10 | 83.3 | — | — |
| Spinetoram | 1 | 50 | — | — |
| Spinetoram | 3 | 33.3 | — | — |
| Novaluron + | 0.1 + 10 | 100 | 86.09 | 1.16 |
| Spinetoram | | | | |
| Novaluron + | 1 + 1 | 67.7 | 58.35 | 1.16 |
| Spinetoram | | | | |
| Novaluron + | 300 + 3 | 50 | 44.44 | 1.13 |
| Spinetoram | | | | |

D)
Synergistic activity of a Novaluron + Spinetoram against F. occidentalis, 48 hours after treatment

| | | | | |
|---|---|---|---|---|
| Novaluron | 3.5 | 4.0 | — | — |
| Spinetoram | 3.5 | 18.0 | — | — |
| Spinetoram | 350 | 78.0 | — | — |
| Novaluron + Spinetoram | 3.5 + 3.5 | 30.0 | 21.3 | 1.41 |
| Novaluron + Spinetoram | 3.5 + 350 | 88.0 | 78.9 | 1.12 |

E)
Synergistic activity of a Novaluron + Spinetoram against F. occidentalis, 72 hours after treatment

| | | | | |
|---|---|---|---|---|
| Novaluron | 3.5 | 4.0 | — | — |
| Spinetoram | 3.5 | 22.0 | — | — |
| Spinetoram | 350 | 82.0 | — | — |
| Novaluron + Spinetoram | 3.5 + 3.5 | 38.0 | 25.1 | 1.51 |
| Novaluron + Spinetoram | 3.5 + 350 | 90.0 | 82.7 | 1.09 |

F)
Synergistic activity of a Novaluron + Spinetoram against F. occidentalis, 7 days after treatment

| | | | | |
|---|---|---|---|---|
| Novaluron | 3.5 | 8.0 | — | — |
| Spinetoram | 3.5 | 30.0 | — | — |
| Spinetoram | 350 | 82.0 | — | — |
| Novaluron + Spinetoram | 3.5 + 3.5 | 40.0 | 35.6 | 1.12 |
| Novaluron + Spinetoram | 3.5 + 350 | 94.0 | 83.4 | 1.13 |

TABLE 6
Novaluron + Spirotetramat

| | | | | |
|---|---|---|---|---|
| | | Observed % | Expected % | Synergism ratio |
| Active ingredient | Rate (ppm) | control (O) | control (E) | (R) |

A)
Synergistic activity of a Novaluron + Spirotetramat against M. persicae, 72 hours after treatment

| | | | | |
|---|---|---|---|---|
| Novaluron | 1 | 34 | — | — |
| Spirotetramat | 100 | 68 | — | — |
| Novaluron + | 1 + 100 | 86 | 78.9 | 1.09 |
| Spirotetramat | | | | |

B)
Synergistic activity of a Novaluron + Spirotetramat against M. persicae, 7 days after treatment

| | | | | |
|---|---|---|---|---|
| Novaluron | 1 | 38.8 | — | — |
| Spirotetramat | 100 | 85.7 | — | — |
| Novaluron + | 1 + 100 | 98.0 | 91.3 | 1.07 |
| Spirotetramat | | | | |

C)
Synergistic activity of a Novaluron + Spirotetramat against T. urticae, 48 hours after treatment

| | | | | |
|---|---|---|---|---|
| Novaluron | 6 | 0 | — | — |
| Spirotetramat | 600 | 8.0 | — | — |
| Novaluron + | 6 + 600 | 13.0 | 8.0 | 1.63 |
| Spirotetramat | | | | |

D)
Synergistic activity of a Novaluron + Spirotetramat against T. urticae, 72 hours after treatment

| | | | | |
|---|---|---|---|---|
| Novaluron | 6 | 0 | — | — |
| Spirotetramat | 6 | 6.0 | — | — |
| Spirotetramat | 600 | 14.0 | — | — |
| Novaluron + | 6 + 6 | 7.0 | 6.0 | 1.17 |
| Spirotetramat | | | | |
| Novaluron + | 6 + 600 | 27.0 | 14.0 | 1.93 |
| Spirotetramat | | | | |

E)
Synergistic activity of a Novaluron + Spirotetramat against T. urticae, 7 days after treatment

| | | | | |
|---|---|---|---|---|
| Novaluron | 6 | 6.1 | — | — |
| Spirotetramat | 600 | 16.2 | — | — |
| Novaluron + | 6 + 600 | 27.3 | 21.2 | 1.28 |
| Spirotetramat | | | | |

TABLE 7
Novaluron + Afidopyropen
Synergistic activity of a Novaluron + Afidopyropen
against B. tabaci, 72 hours after treatment

| | | Observed % | Expected % | Synergism |
|---|---|---|---|---|
| Active | Rate | control | control | ratio |
| ingredient | (ppm) | (O) | (E) | (R) |
| Novaluron | 7 | 23.1 | — | — |
| Novaluron | 35 | 25.2 | — | — |
| Afidopyropen | 7 | 35.1 | — | — |
| Afidopyropen | 35 | 49.8 | — | — |
| Novaluron + | 7 + 35 | 73.2 | 61.4 | 1.19 |
| Afidopyropen | | | | |
| Novaluron + | 35 + 7 | 58.5 | 51.45 | 1.14 |
| Afidopyropen | | | | |

TABLE 8
Novaluron + Isocycloseram
Synergistic activity of a Novaluron + Isocycloseram
against Cotton Leafworm, S. littoralis, 72 hours after treatment

| | | Observed % | Expected % | Synergism |
|---|---|---|---|---|
| Active | Rate | control | control | ratio |
| ingredient | (ppm) | (O) | (E) | (R) |
| Novaluron | 12 | 75 | — | — |
| Isocycloseram | 12 | 12.5 | — | — |
| Novaluron + | 12 + 12 | 87.5 | 78.1 | 1.12 |
| Isocycloseram | | | | |

TABLE 9
Novaluron + Broflanilide
Synergistic activity of a Novaluron + Broflanilide
against S. frugiperda, 120 hours after treatment

| | | Observed % | Expected % | Synergism |
|---|---|---|---|---|
| Active | Rate | control | control | ratio |
| ingredient | (ppm) | (O) | (E) | (R) |
| Novaluron | 0.01 | 27 | — | — |
| Novaluron | 0.025 | 30 | — | — |
| Broflanilide | 0.01 | 20 | — | — |
| Broflanilide | 0.001 | 10 | — | — |
| Novaluron + | 0.01 + 0.01 | 80 | 41.6 | 1.92 |
| Broflanilide | | | | |
| Novaluron + | 0.01 + 0.001 | 40 | 34.3 | 1.17 |
| Broflanilide | | | | |
| Novaluron + | 0.025 + 0.01 | 75 | 44 | 1.70 |
| Broflanilide | | | | |

TABLE 10
Novaluron + Tetraniliprole

| | | | | |
|---|---|---|---|---|
| | | Observed % | Expected % | Synergism ratio |
| Active ingredient | Rate (ppm) | control (O) | control (E) | (R) |

A)
Synergistic activity of a Novaluron + Tetraniliprole against S. frugiperda, 120 hours after treatment

| | | | | |
|---|---|---|---|---|
| Novaluron | 0.025 | 30 | — | — |
| Tetraniliprole | 0.01 | 0 | — | — |
| Tetraniliprole | 0.001 | 0 | — | — |
| Novaluron + | 0.025 + 0.01 | 80 | 30 | 2.67 |
| Tetraniliprole | | | | |
| Novaluron + | 0.025 + 0.001 | 40 | 30 | 1.33 |
| Tetraniliprole | | | | |

B)
Synergistic activity of a Novaluron + Tetraniliprole against S. littoralis, 72 hours after treatment

| Novaluron | 0.02 | 30 | — | — |
|---|---|---|---|---|
| Tetraniliprole | 0.1 | 95 | — | — |
| Tetraniliprole | 0.02 | 17.5 | — | — |
| Tetraniliprole | 0.004 | 7.5 | — | — |
| Novaluron + | 0.02 + 0.1 | 97.5 | 96.5 | 1.01 |
| Tetraniliprole | | | | |
| Novaluron + | 0.02 + 0.02 | 55 | 42.25 | 1.30 |
| Tetraniliprole | | | | |
| Novaluron + | 0.02 + 0.004 | 50 | 35.25 | 1.42 |
| Tetraniliprole | | | | |

TABLE 11
Novaluron + Dicloromezotiaz
Synergistic activity of a Novaluron + Dicloromezotiaz
against Cotton Leafworm, S. littoralis, 72 hours after treatment

| | | Observed % | Expected % | Synergism |
|---|---|---|---|---|
| Active | Rate | control | control | ratio |
| ingredient | (ppm) | (O) | (E) | (R) |
| Novaluron | 12 | 25 | — | — |
| Dicloromezotiaz | 12 | 0 | — | — |
| Novaluron + | 12 + 12 | 37.5 | 25 | 1.5 |
| Dicloromezotiaz | | | | |

TABLE 12
Novaluron + Flupyrimin
Synergistic activity of a Novaluron + Flupyrimin
against Cotton Leafworm, S. littoralis, 72 hours after treatment

| | | Observed % | Expected % | Synergism |
|---|---|---|---|---|
| Active | Rate | control | control | ratio |
| ingredient | (ppm) | (O) | (E) | (R) |
| Novaluron | 12 | 75 | — | — |
| Flupyrimin | 12 | 0 | — | — |
| Novaluron + | 12 + 12 | 87.5 | 75 | 1.17 |
| Flupyrimin | | | | |

TABLE 13
Novaluron + Tyclopyrazoflor
Synergistic activity of a Novaluron + Tyclopyrazoflor
against Cotton Leafworm, S. littoralis, 72 hours after treatment

| | | Observed % | Expected % | Synergism |
|---|---|---|---|---|
| Active | Rate | control | control | ratio |
| ingredient | (ppm) | (O) | (E) | (R) |
| Novaluron | 12 | 75 | — | — |
| Tyclopyrazoflor | 12 | 12.5 | — | — |
| Novaluron + | 12 + 12 | 87.5 | 78.1 | 1.12 |
| Tyclopyrazoflor | | | | |

TABLE 14
Novaluron + Chlorfenapyr

| | | | | |
|---|---|---|---|---|
| | | Observed % | Expected % | |
| Active ingredient | Rate (ppm) | control (O) | control (E) | Synergism ratio (R) |

A)
Synergistic activity of a Novaluron + Chlorfenapyr against T. urticae, 48 hours after treatment

| | | | | |
|---|---|---|---|---|
| Novaluron | 2.4 | 12 | — | — |
| Novaluron | 120 | 8 | — | — |
| Chlorfenapyr | 2.4 | 64 | — | — |
| Chlorfenapyr | 24 | 79 | — | — |
| Novaluron + Chlorfenapyr | 2.4 + 2.4 | 87 | 68.3 | 1.27 |
| Novaluron + Chlorfenapyr | 2.4 + 24 | 100 | 81.5 | 1.23 |
| Novaluron + Chlorfenapyr | 120 + 2.4 | 82 | 66.9 | 1.23 |

B)
Synergistic activity of a Novaluron + Chlorfenapyr against T. urticae, 72 hours after treatment

| | | | | |
|---|---|---|---|---|
| Novaluron | 2.4 | 13 | — | — |
| Novaluron | 120 | 10 | — | — |
| Chlorfenapyr | 2.4 | 78 | — | — |
| Chlorfenapyr | 24 | 86 | — | — |
| Novaluron + Chlorfenapyr | 2.4 + 2.4 | 87 | 80.9 | 1.08 |
| Novaluron + Chlorfenapyr | 2.4 + 24 | 100 | 87.8 | 1.14 |
| Novaluron + Chlorfenapyr | 120 + 2.4 | 83 | 80.2 | 1.03 |

C)
Synergistic activity of a Novaluron + Chlorfenapyr against T. urticae, 7 days after treatment

| | | | | |
|---|---|---|---|---|
| Novaluron | 2.4 | 15 | — | — |
| Novaluron | 120 | 17 | — | — |
| Chlorfenapyr | 2.4 | 86 | — | — |
| Chlorfenapyr | 24 | 94 | — | — |
| Novaluron + Chlorfenapyr | 2.4 + 2.4 | 97 | 88.1 | 1.10 |
| Novaluron + Chlorfenapyr | 2.4 + 24 | 100 | 94.9 | 1.05 |
| Novaluron + Chlorfenapyr | 120 + 2.4 | 98 | 88.4 | 1.11 |

TABLE 15
Novaluron + Sulfoxaflor

| | | | | |
|---|---|---|---|---|
| | | Observed % | Expected % | Synergism ratio |
| Active ingredient | Rate (ppm) | control (O) | control (E) | (R) |

A)
Synergistic activity of a Novaluron + Sulfoxaflor against M. persicae, 48 hours after treatment

| | | | | |
|---|---|---|---|---|
| Novaluron | 50 | 14 | — | — |
| Sulfoxaflor | 0.5 | 64 | — | — |
| Novaluron + | 50 + 0.5 | 74 | 69 | 1.07 |
| Sulfoxaflor | | | | |

B)
Synergistic activity of a Novaluron + Sulfoxaflor against M. persicae, 72 hours after treatment

| | | | | |
|---|---|---|---|---|
| Novaluron | 0.5 | 30 | — | — |
| Novaluron | 50 | 44 | | |
| Sulfoxaflor | 0.5 | 70 | — | — |
| Sulfoxaflor | 2.5 | 82 | | |
| Novaluron + | 0.5 + 2.5 | 92 | 87.4 | 1.05 |
| Sulfoxaflor | | | | |
| Novaluron + | 50 + 0.5 | 96 | 83.2 | 1.15 |
| Sulfoxaflor | | | | |

TABLE 16
Novaluron + Dinotefuran
Synergistic activity of a Novaluron + Dinotefuran
against Cotton Leafworm, S. littoralis, 72 hours after treatment

| | | Observed % | Expected % | Synergism |
|---|---|---|---|---|
| Active | Rate | control | control | ratio |
| ingredient | (ppm) | (O) | (E) | (R) |
| Novaluron | 0.04 | 73 | — | — |
| Dinotefuran | 0.04 | 25 | — | — |
| Novaluron + | 0.04 + 0.04 | 80 | 79.75 | 1.003 |
| Dinotefuran | | | | |

TABLE 17
Novaluron + Acephate

| | | | | |
|---|---|---|---|---|
| | | Observed % | Expected % | Synergism ratio |
| Active ingredient | Rate (ppm) | control (O) | control (E) | (R) |

A)
Synergistic activity of a Novaluron + Acephate against M. persicae, 72 hours after treatment

| | | | | |
|---|---|---|---|---|
| Novaluron | 0.2 | 56 | — | — |
| Acephate | 2 | 66 | — | — |
| Novaluron + | 0.2 + 2 | 88 | 85.0 | 1.03 |
| Acephate | | | | |

B)
Synergistic activity of a Novaluron + Acephate against M. persicae, 7 days after treatment

| | | | | |
|---|---|---|---|---|
| Novaluron | 0.2 | 62.5 | — | — |
| Acephate | 2 | 75.0 | — | — |
| Novaluron + | 0.2 + 2 | 95.8 | 90.6 | 1.06 |
| Acephate | | | | |

TABLE 18
Novaluron + Malathion

| | | | | |
|---|---|---|---|---|
| | | Observed % | Expected % | Synergism ratio |
| Active ingredient | Rate (ppm) | control (O) | control (E) | (R) |

A)
Synergistic activity of a Novaluron + Malathion against A. gossypii, 96 hours after treatment

| Novaluron | 10 | 16.2 | — | — |
|---|---|---|---|---|
| Malathion | 100 | 81.7 | — | — |
| Novaluron + | 10 + 100 | 100 | 84.665 | 1.18 |
| Malathion | | | | |

B)
Synergistic activity of a Novaluron + Malathion against F. occidentalis, 72 hours after treatment

| | | | | |
|---|---|---|---|---|
| Novaluron | 5 | 10.0 | — | — |
| Novaluron | 500 | 10.0 | — | — |
| Malathion | 5 | 6.0 | — | — |
| Malathion | 500 | 80.0 | — | — |
| Novaluron + | 5 + 5 | 18.0 | 15.4 | 1.17 |
| Malathion | | | | |

TABLE 19
Novaluron + Spiromesifen

| | | | | |
|---|---|---|---|---|
| | | Observed % | Expected % | Synergism ratio |
| Active ingredient | Rate (ppm) | control (O) | control (E) | (R) |

A)
Synergistic activity of a Novaluron + Spiromesifen against A. gossypii, 96 hours after treatment

| | | | | |
|---|---|---|---|---|
| Novaluron | 100 | 16.5 | — | — |
| Spiromesifen | 500 | 75.3 | — | — |
| Novaluron + | 100 + 500 | 82.3 | 79.38 | 1.04 |
| Spiromesifen | | | | |

B)
Synergistic activity of a Novaluron + Spiromesifen against M. persicae, 7 days after treatment

| Novaluron | 500 | 72.9 | — | — |
|---|---|---|---|---|
| Spiromesifen | 5 | 58.3 | — | — |
| Novaluron + | 500 + 5 | 89.6 | 88.7 | 1.01 |
| Spiromesifen | | | | |

TABLE 20
Novaluron + Fipronil

| | | | | |
|---|---|---|---|---|
| | | Observed % | Expected % | Synergism ratio |
| Active ingredient | Rate (ppm) | control (O) | control (E) | (R) |

A)
Synergistic activity of a Novaluron + Fipronil against Cotton Leafworm, S. littoralis, 72 hours after treatment

| | | | | |
|---|---|---|---|---|
| Novaluron | 0.02 | 0 | — | — |
| Novaluron | 0.2 | 5 | — | — |
| Fipronil | 0.02 | 5 | — | — |
| Fipronil | 0.002 | 0 | — | — |
| Novaluron + | 0.02 + 0.02 | 10 | 5 | 2 |
| Fipronil | | | | |
| Novaluron + | 0.2 + 0.002 | 25 | 5 | 5 |
| Fipronil | | | | |

B)
Synergistic activity of a Novaluron + Fipronil against H. halys 144 hours after treatment

| | | | | |
|---|---|---|---|---|
| Novaluron | 50 | 12.5 | — | — |
| Fipronil | 5 | 87.5 | — | — |
| Novaluron + | 50 + 5 | 100 | 89.06 | 1.12 |
| Fipronil | | | | |

C)
Synergistic activity of a Novaluron + Fipronil against F. occidentalis 48 hours after treatment

| | | | | |
|---|---|---|---|---|
| Novaluron | 1 | 16.0 | — | — |
| Fipronil | 1 | 66.0 | — | — |
| Novaluron + | 1 + 1 | 72.0 | 71.4 | 1.01 |
| Fipronil | | | | |

D)
Synergistic activity of a Novaluron + Fipronil against F. occidentalis, 72 hours after treatment

| | | | | |
|---|---|---|---|---|
| Novaluron | 1 | 50.0 | — | — |
| Novaluron | 100 | 50.0 | — | — |
| Fipronil | 1 | 70.0 | — | — |
| Fipronil | 100 | 90.0 | — | — |
| Novaluron + Fipronil | 1 + 1 | 90.0 | 85.0 | 1.06 |
| Novaluron + Fipronil | 1 + 100 | 98.0 | 95.0 | 1.03 |
| Novaluron + Fipronil | 100 + 1 | 94.0 | 85.0 | 1.11 |

E)
Synergistic activity of a Novaluron + Fipronil against F. occidentalis 7 days after treatment

| | | | | |
|---|---|---|---|---|
| Novaluron | 1 | 74.0 | — | — |
| Novaluron | 100 | 84.0 | | |
| Fipronil | 1 | 84.0 | | |
| Novaluron + | 100 + 1 | 100.0 | 97.4 | 1.03 |
| Fipronil | | | | |

TABLE 21
Novaluron + Nicofluprole
Synergistic activity of a Novaluron + Nicofluprole
against Cotton Leafworm, S. littoralis, 72 hours after treatment

| | | Observed % | Expected % | Synergism |
|---|---|---|---|---|
| Active | Rate | control | control | ratio |
| ingredient | (ppm) | (O) | (E) | (R) |
| Novaluron | 12 | 12.5 | — | — |
| Nicofluprole | 12 | 0 | — | — |
| Novaluron + | 12 + 12 | 50 | 12.5 | 4 |
| Nicofluprole | | | | |

While the present invention has been shown and described with reference to preferred embodiments thereof, it will be understood by those skilled in the art that many alternatives, modifications and variations may be made thereto without departing from the spirit and scope thereof. Accordingly, it is intended to embrace all such alternatives, modifications, and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference.

What is claimed is:

1. A pesticidal mixture comprising, as active compounds:
i) a compound I, which is novaluron of formula (I) 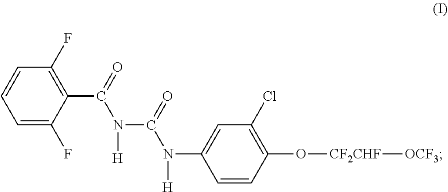
and
ii) at least one active compound II selected from the groups A.1 to A.26:
A.1. Diacylhydrazine insecticides, which are ecdysone agonists, selected from the group comprising chromafenozide, halofenozide, methoxyfenozide and tebufenozide.
A.2. Pyrethroid insecticides, selected from the group comprising Tau fluvalinate, lambda-cyhalothrin and bifenthrin.
A.3. Spinosyns insecticides, selected from the group comprising spinosad and spinetoram.
A.4. Tetramic acids, cyclic ketoenoles insecticides, which are acetyl COA carboxylase (ACC) inhibitors, selected from the group comprising Spiropidion and spirotetramat.
A.5. METI (Mitochondrial complex I electron transport inhibitors) acaricides and insecticides, selected from the group comprising Tolfenpyrad.
A.6. A pyridine organic compound, which is a Chortodonal Organ Modulator, selected from the group comprising Flonicamid.
A.7. The Chortodonal Organ TRPV (vanilloid-type transient receptor potential) Channel Modulators, selected from the group comprising pymetrozine, afidopyropen and pyrifluquinazon.
A.8. Arylisoxazolines, which are γ-aminobutyric acid (GABA)-gated chloride channel allosteric modulators, selected from the group comprising Fluxametamid and Isocycloseram.
A.9. Meta-diamides, which are GABA-gated chloride channel allosteric modulators, selected from the group comprising broflanilide.
A.10. An insecticidal class of diamides, which are highly specific Ryanodin receptor (RyR) modulators, selected from the group comprising Cyclaniliprole and tetraniliprole.
A.11. An arylalkyloxypyrimidine compound, selected from the group comprising Benzpyrimoxan.
A.12. A mesoionic pyrido[1,2-α]pyrimidinones, selected from the group comprising dicloromezotiaz.
A.13. A novel quinoline insecticide, selected from the group comprising Flometoquin.
A.14. A novel chemotype insecticide, selected from the group comprising Flupyrimin.
A.15. An aryl ethylsulfonyl compound, selected from the group comprising Oxazosulfyl.
A.16. An organofluorine compound, selected from the group comprising Tyclopyrazoflor.
A.17. A pyrazole carboxamide insecticide, selected from the group comprising dimpropyridaz.
A.18. A Pyrrole compound, selected from the group comprising Chlorfenapyr.
A.19. A sulfoximine compound, selected from the group comprising Sulfoxaflor.
A.20. A furanicotinyl compound, selected from the group comprising Dinotefuran.
A.21. An organophosphate compound, selected from the group comprising Acephate and Malathion.
A.22. A foliar contact insecticide, selected from the group comprising Spiromesifen.
A.23. A phenylpyrazole chemical compound, selected from the group comprising Fipronil.
A.24. A tetramic acid insecticide, selected from the group comprising Spidoxamat.
A.25. A Phenylpyrazole insecticide, selected from the group comprising Nicofluprole.
A.26. An Ecdysteroid compound, selected from the group comprising Ecdysone.

2. The pesticidal mixture of claim 1, wherein the diacylhydrazine insecticide is methoxyfenozide.

3. The pesticidal mixture of claim 1, wherein the Pyrethroid insecticide is Tau fluvalinate.

4. The pesticidal mixture of claim 1, wherein the Spinosyns insecticide is Spinosad.

5. The pesticidal mixture of claim 1, wherein the Spinosyns insecticide is spinetoram.

6. The pesticidal mixture of claim 1, wherein the Tetramic acids, cyclic ketoenoles insecticide is Spiropidion.

7. The pesticidal mixture of claim 1, wherein the Tetramic acids, cyclic ketoenoles insecticide is spirotetramat.

8. The pesticidal mixture of claim 1, wherein the METI insecticide is Tolfenpyrad.

9. The pesticidal mixture of claim 1, wherein the pyridine organic compound is Flonicamid.

10. The pesticidal mixture of claim 1, wherein the Chortodonal Organ TRPV Channel Modulator is pymetrozine.

11. The pesticidal mixture of claim 1, wherein the Chortodonal Organ TRPV Channel Modulator is afidopyropen.

12. The pesticidal mixture of claim 1, wherein the Arylisoxazoline is Fluxametamid.

13. The pesticidal mixture of claim 1, wherein the Arylisoxazoline is Isocycloseram.

14. The pesticidal mixture of claim 1, wherein the Meta-diamide is broflanilide.

15. The pesticidal mixture of claim 1, wherein the diamide is cyclaniliprole.

16. The pesticidal mixture of claim 1, wherein the diamide is tetraniliprole.

17. The pesticidal mixture of claim 1, wherein the arylalkyloxypyrimidine compound is Benzpyrimoxan.

18. The pesticidal mixture of claim 1, wherein the mesoionic pyrido[1,2-α]pyrimidinone is dicloromezotiaz.

19. The pesticidal mixture of claim 1, wherein the quinoline insecticide is Flometoquin.

20. The pesticidal mixture of claim 1, wherein the chemotype insecticide is Flupyrimin.

21. The pesticidal mixture of claim 1, wherein the aryl ethylsulfonyl compound is Oxazosulfyl.

22. The pesticidal mixture of claim 1, wherein the organofluorine compound is Tyclopyrazoflor.

23. The pesticidal mixture of claim 1, wherein the pyrazole carboxamide insecticide is dimpropyridaz.

24. The pesticidal mixture of claim 1, wherein the Pyrrole compound is Chlorfenapyr.

25. The pesticidal mixture of claim 1, wherein the sulfoximine compound is Sulfoxaflor.

26. The pesticidal mixture of claim 1, wherein the furanicotinyl compound is Dinotefuran.

27. The pesticidal mixture of claim 1, wherein the organophosphate compound is Acephate.

28. The pesticidal mixture of claim 1, wherein the organophosphate compound is Malathion.

29. The pesticidal mixture of claim 1, wherein the foliar contact insecticide is Spiromesifen.

30. The pesticidal mixture of claim 1, wherein the phenylpyrazole chemical compound is Fipronil.

31. The pesticidal mixture of claim 1, wherein the tetramic acid insecticide is Spidoxamat.

32. The pesticidal mixture of claim 1, wherein the Phenylpyrazole insecticide is Nicofluprole.

33. The pesticidal mixture of claim 1, wherein the Ecdysteroid compound is Ecdysone.

34. The pesticidal mixture of any one of claims 1-33, wherein the mixture exhibits synergistic effects.

35. The pesticidal mixture of any one of claims 1-34, wherein novaluron and at least one active compound II, as defined in claim 1, are applied jointly or in a succession.

36. The pesticidal mixture of any one of claims 1-35, wherein the weight ratio of novaluron and at least one active compound II, as defined in claim 1, is from 1:100 to 100:1.

37. The pesticidal mixture of claim 34, wherein the weight ratio of novaluron and diacylhydrazine insecticide is from 1:100 to 100:1.

38. The pesticidal mixture of claim 37, wherein the weight ratio of novaluron and Methoxyfenozide is from 1:1 to 100:1.

39. The pesticidal mixture of claim 34, wherein the weight ratio of novaluron and Spinosyns insecticide is from 1:100 to 100:1.

40. The pesticidal mixture of claim 39, wherein the weight ratio of novaluron and Spinosad is from 1:1 to 1:100.

41. The pesticidal mixture of claim 39, wherein the weight ratio of novaluron and Spinetoram is from 100:1 to 1:100.

42. The pesticidal mixture of claim 34, wherein the weight ratio of novaluron and one of acetyl CoA carboxylase (ACC) inhibitors insecticide is from 1:100 to 100:1.

43. The pesticidal mixture of claim 42, wherein the weight ratio of novaluron and Spirotetramat is from 1:1 to 1:100.

44. The pesticidal mixture of claim 34, wherein the weight ratio of novaluron and one of Chortodonal Organ TRPV (vanilloid-type transient receptor potential) Channel Modulator insecticide is from 1:100 to 100:1.

45. The pesticidal mixture of claim 44, wherein the weight ratio of novaluron and afidopyropen is from 1:5 to 5:1.

46. The pesticidal mixture of claim 34, wherein the weight ratio of novaluron and one of Arylisoxazolines, which are γ-aminobutyric acid (GABA)-gated chloride channel allosteric modulators insecticide is from 1:100 to 100:1.

47. The pesticidal mixture of claim 46, wherein the weight ratio of novaluron and Isocycloseram is 1:1.

48. The pesticidal mixture of claim 34, wherein the weight ratio of novaluron and one of Meta-diamides, which are GABA-gated chloride channel allosteric modulators insecticide is from 1:100 to 100:1.

49. The pesticidal mixture of claim 48, wherein the weight ratio of novaluron and Broflanilide is from 1:1 to 10:1.

50. The pesticidal mixture of claim 34, wherein the weight ratio of novaluron and one of diamides, which are highly specific Ryanodin receptor (RyR) modulators insecticide is from 1:100 to 100:1.

51. The pesticidal mixture of claim 50, wherein the weight ratio of novaluron and Tetraniliprole is from 1:5 to 25:1.

52. The pesticidal mixture of claim 34, wherein the weight ratio of novaluron and one of mesoionic pyrido[1,2-α]pyrimidinones insecticide is from 1:100 to 100:1.

53. The pesticidal mixture of claim 52, wherein the weight ratio of novaluron and Dicloromezotiaz is 1:1.

54. The pesticidal mixture of claim 34, wherein the weight ratio of novaluron and one of chemotype insecticide is from 1:100 to 100:1.

55. The pesticidal mixture of claim 54, wherein the weight ratio of novaluron and Flupyrimin is 1:1.

56. The pesticidal mixture of claim 34, wherein the weight ratio of novaluron and organofluorine compound insecticide is from 1:100 to 100:1.

57. The pesticidal mixture of claim 56, wherein the weight ratio of novaluron and Tyclopyrazoflor is 1:1.

58. The pesticidal mixture of claim 34, wherein the weight ratio of novaluron and Pyrrole compound insecticide is from 1:100 to 100:1.

59. The pesticidal mixture of claim 58, wherein the weight ratio of novaluron and Chlorfenapyr is from 1:10 to 50:1.

60. The pesticidal mixture of claim 34, wherein the weight ratio of novaluron and sulfoximine compound insecticide is from 1:100 to 100:1.

61. The pesticidal mixture of claim 60, wherein the weight ratio of novaluron and Sulfoxaflor is from 1:5 to 100:1.

62. The pesticidal mixture of claim 34, wherein the weight ratio of novaluron and furanicotinyl compound insecticide is from 1:100 to 100:1.

63. The pesticidal mixture of claim 62, wherein the weight ratio of novaluron and Dinotefuran is 1:1.

64. The pesticidal mixture of claim 34, wherein the weight ratio of novaluron and organophosphate compound insecticide is from 1:100 to 100:1.

65. The pesticidal mixture of claim 64, wherein the weight ratio of novaluron and Acephate is 1:10.

66. The pesticidal mixture of claim 64, wherein the weight ratio of novaluron and Malathion is from 1:1 to 1:10.

67. The pesticidal mixture of claim 34, wherein the weight ratio of novaluron and foliar contact insecticide is from 1:100 to 100:1.

68. The pesticidal mixture of claim 67, wherein the weight ratio of novaluron and Spiromesifen is from 1:5 to 100:1.

69. The pesticidal mixture of claim 34, wherein the weight ratio of novaluron and phenylpyrazole chemical compound insecticide is from 1:100 to 100:1.

70. The pesticidal mixture of claim 69, wherein the weight ratio of novaluron and Fipronil is from 1:100 to 100:1.

71. The pesticidal mixture of claim 34, wherein the weight ratio of novaluron and other Phenylpyrazole insecticide is from 1:100 to 100:1.

72. The pesticidal mixture of claim 71, wherein the weight ratio of novaluron and Nicofluprole is from 1:1.

73. A pesticidal composition comprising: (i) the mixture of any one of claims 1-72; and (ii) an agriculturally acceptable carrier.

74. The pesticidal composition of claim 73, further comprising at least one surfactant, solid diluent, liquid diluent, or a combination thereof.

75. A method of reducing the total amount of insecticidal active compounds necessary for controlling unwanted pests by a) applying novaluron at an application rate from about 25% to about 75% of the recommended application rate and b) applying at least one active compound II, as defined in claim 1.

76. A method for controlling insects comprising contacting the insect or their food supply, habitat, breeding grounds or their locus with an effective amount of the mixture of any one of claims 1-72 or the composition of claim 73 or 74 so as to thereby control insects.

77. The method of claim 76 for controlling the insect, T. absoluta by contacting the insect or their food supply, habitat, breeding grounds or their locus with an effective amount of a synergistic mixture of novaluron and a Diacylhydrazine insecticide, as defined in claim 1, in a ratio from 1:100 to 100:1, so as to thereby controlling the said insect.

78. The method of claim 76 for controlling the insect, T. absoluta by contacting the insect or their food supply, habitat, breeding grounds or their locus with an effective amount of a synergistic mixture of novaluron and a Spinosyns insecticide, as defined in claim 1, in a ratio from 1:100 to 100:1, so as to thereby controlling the said insect.

79. The method of claim 76 for controlling the insect, S. littoralis by contacting the insect or their food supply, habitat, breeding grounds or their locus with an effective amount of a synergistic mixture of novaluron and a Diacylhydrazine insecticide, as defined in claim 1, in a ratio from 1:100 to 100:1, so as to thereby controlling the said insect.

80. The method of claim 76 for controlling the insect, S. littoralis by contacting the insect or their food supply, habitat, breeding grounds or their locus with an effective amount of a synergistic mixture of novaluron and a Spinosyns insecticide, as defined in claim 1, in a ratio from 1:100 to 100:1, so as to thereby controlling the said insect.

81. The method of claim 76 for controlling the insect, S. littoralis by contacting the insect or their food supply, habitat, breeding grounds or their locus with an effective amount of a synergistic mixture of novaluron and one of arylisoxazolines, which are γ-aminobutyric acid (GABA)-gated chloride channel allosteric modulators insecticide, as defined in claim 1, in a ratio from 1:100 to 100:1, so as to thereby controlling the said insect.

82. The method of claim 76 for controlling the insect, S. littoralis by contacting the insect or their food supply, habitat, breeding grounds or their locus with an effective amount of a synergistic mixture of novaluron and one of diamides, which are highly specific Ryanodin receptor (RyR) modulators insecticide, as defined in claim 1, in a ratio from 1:100 to 100:1, so as to thereby controlling the said insect.

83. The method of claim 76 for controlling the insect, S. littoralis by contacting the insect or their food supply, habitat, breeding grounds or their locus with an effective amount of a synergistic mixture of novaluron and one of mesoionic pyrido[1,2-α]pyrimidinones insecticide, as defined in claim 1, in a ratio from 1:100 to 100:1, so as to thereby controlling the said insect.

84. The method of claim 76 for controlling the insect, S. littoralis by contacting the insect or their food supply, habitat, breeding grounds or their locus with an effective amount of a synergistic mixture of novaluron and chemotype insecticide, as defined in claim 1, in a ratio from 1:100 to 100:1, so as to thereby controlling the said insect.

85. The method of claim 76 for controlling the insect, S. littoralis by contacting the insect or their food supply, habitat, breeding grounds or their locus with an effective amount of a synergistic mixture of novaluron and organofluorine compound, as defined in claim 1, in a ratio from 1:100 to 100:1, so as to thereby controlling the said insect.

86. The method of claim 76 for controlling the insect, S. littoralis by contacting the insect or their food supply, habitat, breeding grounds or their locus with an effective amount of a synergistic mixture of novaluron and furanicotinyl compound, as defined in claim 1, in a ratio from 1:100 to 100:1, so as to thereby controlling the said insect.

87. The method of claim 76 for controlling the insect, S. littoralis by contacting the insect or their food supply, habitat, breeding grounds or their locus with an effective amount of a synergistic mixture of novaluron and phenylpyrazole chemical compound, as defined in claim 1, in a ratio from 1:100 to 100:1, so as to thereby controlling the said insect.

88. The method of claim 76 for controlling the insect, S. littoralis by contacting the insect or their food supply, habitat, breeding grounds or their locus with an effective amount of a synergistic mixture of novaluron and Phenylpyrazole insecticide, as defined in claim 1, in a ratio from 1:100 to 100:1, so as to thereby controlling the said insect.

89. The method of claim 76 for controlling the insect, F. occidentalis by contacting the insect or their food supply, habitat, breeding grounds or their locus with an effective amount of a synergistic mixture of novaluron and Spinosyns insecticide, as defined in claim 1, in a ratio from 1:100 to 100:1, so as to thereby controlling the said insect.

90. The method of claim 76 for controlling the insect, F. occidentalis by contacting the insect or their food supply, habitat, breeding grounds or their locus with an effective amount of a synergistic mixture of novaluron and organophosphate compound insecticide, as defined in claim 1, in a ratio from 1:100 to 100:1, so as to thereby controlling the said insect.

91. The method of claim 76 for controlling the insect, F. occidentalis by contacting the insect or their food supply, habitat, breeding grounds or their locus with an effective amount of a synergistic mixture of novaluron and phenylpyrazole chemical compound insecticide, as defined in claim 1, in a ratio from 1:100 to 100:1, so as to thereby controlling the said insect.

92. The method of claim 76 for controlling the insect, S. frugiperda by contacting the insect or their food supply, habitat, breeding grounds or their locus with an effective amount of a synergistic mixture of novaluron and Spinosyns insecticide, as defined in claim 1, in a ratio from 1:100 to 100:1, so as to thereby controlling the said insect.

93. The method of claim 76 for controlling the insect, S. frugiperda by contacting the insect or their food supply, habitat, breeding grounds or their locus with an effective amount of a synergistic mixture of novaluron and one of Meta-diamides, which are GABA-gated chloride channel allosteric modulators insecticide, as defined in claim 1, in a ratio from 1:100 to 100:1, so as to thereby controlling the said insect.

94. The method of claim 76 for controlling the insect, S. frugiperda by contacting the insect or their food supply, habitat, breeding grounds or their locus with an effective amount of a synergistic mixture of novaluron and one of diamides, which are highly specific Ryanodin receptor (RyR) modulators insecticide, as defined in claim 1, in a ratio from 1:100 to 100:1, so as to thereby controlling the said insect.

95. The method of claim 76 for controlling the insect, M. persicae by contacting the insect or their food supply, habitat, breeding grounds or their locus with an effective amount of a synergistic mixture of novaluron and one of acetyl CoA carboxylase (ACC) inhibitor insecticide, as defined in claim 1, in a ratio from 1:100 to 100:1, so as to thereby controlling the said insect.

96. The method of claim 76 for controlling the insect, M. persicae by contacting the insect or their food supply, habitat, breeding grounds or their locus with an effective amount of a synergistic mixture of novaluron and organophosphate compound insecticide, as defined in claim 1, in a ratio from 1:100 to 100:1, so as to thereby controlling the said insect.

97. The method of claim 76 for controlling the insect, M. persicae by contacting the insect or their food supply, habitat, breeding grounds or their locus with an effective amount of a synergistic mixture of novaluron and foliar contact insecticide, as defined in claim 1, in a ratio from 1:100 to 100:1, so as to thereby controlling the said insect.

98. The method of claim 76 for controlling the insect, T. urticae by contacting the insect or their food supply, habitat, breeding grounds or their locus with an effective amount of a synergistic mixture of novaluron and one of acetyl COA carboxylase (ACC) inhibitors insecticide, as defined in claim 1, in a ratio from 1:100 to 100:1, so as to thereby controlling the said insect.

99. The method of claim 76 for controlling the insect, T. urticae by contacting the insect or their food supply, habitat, breeding grounds or their locus with an effective amount of a synergistic mixture of novaluron and Pyrrole compound insecticide, as defined in claim 1, in a ratio from 1:100 to 100:1, so as to thereby controlling the said insect.

100. The method of claim 76 for controlling the insect, B. tabaci by contacting the insect or their food supply, habitat, breeding grounds or their locus with an effective amount of a synergistic mixture of novaluron and Chortodonal Organ TRPV (vanilloid-type transient receptor potential) Channel Modulator insecticide, as defined in claim 1, in a ratio from 1:100 to 100:1, so as to thereby controlling the said insect.

101. The method of claim 76 for controlling the insect, A. gossyppii by contacting the insect or their food supply, habitat, breeding grounds or their locus with an effective amount of a synergistic mixture of novaluron and organophosphate compound insecticide, as defined in claim 1, in a ratio from 1:100 to 100:1, so as to thereby controlling the said insect.

102. The method of claim 76 for controlling the insect, A. gossyppii by contacting the insect or their food supply, habitat, breeding grounds or their locus with an effective amount of a synergistic mixture of novaluron and foliar contact insecticide, as defined in claim 1, in a ratio from 1:100 to 100:1, so as to thereby controlling the said insect.

103. The method of claim 76 for controlling the insect, H. halys by contacting the insect or their food supply, habitat, breeding grounds or their locus with an effective amount of a synergistic mixture of novaluron and phenylpyrazole chemical compound insecticide, as defined in claim 1, in a ratio from 1:100 to 100:1, so as to thereby controlling the said insect.

104. A method for protecting plants from attack or infestation by insects comprising contacting the plant, or the soil or water in which the plant is growing, with an effective amount of the mixture of any one of claims 1-72 or the composition of claim 73 or 74 so as to thereby protect plants from attack or infestation by insects.

105. A method for enhancing knock-down activity and/or prolonged control comprising contacting the plant, or the soil or water in which the plant is growing, with an effective amount of the mixture of any one of claims 1-72 or the composition of any one of claim 73 or 74 so as to thereby enhance knock-down activity and/or prolonged control.

106. A method for enhancing plant development comprising applying to the plant, a locus of the plant and/or propagation material of the plant an effective amount of the mixture of any one of claims 1-72 or the composition of claim 73 or 74 so as to thereby enhance plant development.

107. A method for regulating plant growth comprising applying to the plant, a locus of the plant and/or propagation material of the plant an effective amount of the mixture of any one of claims 1-72 or the composition of claim 73 or 74 so as to thereby regulate plant growth.
